(19) United States
(12) Patent Application Publication
(10) Pub. No.: US 2009/0128908 A1
(43) Pub. Date: May 21, 2009

(54) Polarization Split Element and Production Method Thereof, and Optical Pickup, Optical Device, Optical Isolator and Polarizing Hologram Provided with the Polarization Split Element

(76) Inventors: Tatsuhiro Nakazawa, Tokyo (JP); Keiji Tsunetomo, Tokyo (JP); Junji Nishii, Osaka (JP)

Correspondence Address: HAMRE, SCHUMANN, MUELLER & LARSON, P.C., P.O. BOX 2902, MINNEAPOLIS, MN, 55402-0902, US

(21) Appl. No.: 11/992,159

(22) PCT Filed: Nov. 8, 2006
(86) PCT No.: PCT/JP2006/322283

§ 371 Date: Mar. 17, 2008

(30) Foreign Application Priority Data
Nov. 9, 2005 (JP) 2005-355362

(51) Int. Cl. G02B 5/30; B29D 11/00

(52) U.S. Cl. 359/495; 264/1.34

(57) ABSTRACT

A polarization split element 1 includes a substrate 2 and a plurality of ridge-shaped convex portions 3 provided in parallel with one another at equal intervals on the substrate 2, and performs polarization splitting with respect to light beams 4 incident to the plurality of the convex portions 3 by diffraction. This polarization split element 1 satisfies a conditional expression represented by: 1.6≦n≦2.2 and 0.6≦P/λ≦0.8, where n denotes a refractive index of the convex portion 3 with respect to the incident light beam 4, P denotes a grating period that is a sum of the interval between the adjacent convex portions 3 and a width of the convex portion 3, and λ denotes a wavelength of the incident light beam 4, and splits the incident light beams 4 into: a TM polarization zeroth-order diffracted light beam whose magnetic field has a vibration direction that is the same as a length direction of the convex portion 3; and a TE polarization first-order diffracted light beam whose electric field has a vibration direction that is the same as a length direction of the convex portion 3. According to the configuration of this polarization split element 1, it is possible to provide a polarization split element that can decrease a grating height and an aspect ratio while maintaining its high performance.

### TECHNICAL FIELD

The present invention relates to a polarization split element that performs polarization splitting by utilizing diffraction and a production method thereof, and an optical pickup, an optical device, an optical isolator and a polarizing hologram provided with the polarization split element.

### BACKGROUND ART

For example, optical elements for controlling light often are used for optical information communication devices, displays, optical pickups, optical sensors and the like. Also, as these devices have been provided with higher functions, higher functions, increases of added values, cost reductions and the like have been demanded for the optical elements.

Recently, a fine structural body having an optical function has been developed. For example, a lens having fine projections and recesses on a surface thereof has a chromatic aberration correction function, functions as a bifocal lens and the like. Moreover, a so-called “Moth Eye” structure in which cone-shaped or pyramid-shaped protrusions having a size smaller than a wavelength of light are arranged periodically on a glass surface has a characteristic that a reflectance of light is small at a large incident angle. According to the “Moth Eye” structure, the reflectance of light can be decreased to 0.1% or less at an incident angle larger than that of an antireflection coating using a dielectric multilayer film as a conventional example, for example. And, by adopting the “Moth Eye” structure, it is possible to suppress a surface reflection loss that causes a problem to optical lenses, glass plates of solar batteries, displays and the like, for example. Moreover, a comb-shaped grating structure that is formed on the substrate and has a pitch smaller than the wavelength of the light exhibits structural birefringence strongly, and thus is used as a wave plate. A birefringent crystal plate that is used for a conventional wave plate is expensive, but this grating structure does not require such an expensive plate and uses a processable substrate, and thus can be produced at a low cost. Since the substrate in which a plurality of such fine structural bodies are formed has a plurality of functions, multifunctionality of the substrate is expected.

As one of the optical elements, a polarization element is exemplified. The polarization element is an optical element that controls light according to a polarization. As one of the polarization elements, a polarizing plate is exemplified. The polarizing plate has a property of allowing one-directional polarized light to pass through. An optical isolator that often is used in the field of optical communications is provided with the polarizing plates. The optical isolator is an optical device for propagating light only in one direction. For example, in a semiconductor laser, an optical fiber amplifier and the like, the optical isolator is used for preventing the increase of noises that are caused by return light. The optical isolator is structured by combining a pair of polarizing plates with a Faraday rotator that is a nonreciprocal device for rotating a direction of polarization.

Moreover, an optical element, among the polarization elements, that has a function for branching different polarized light beams is called a polarization split element. For example, in a pickup system of an optical disc, a polarization beam splitter, a polarizing hologram or the like that is one of the polarization split elements is mounted. The polarizing beam splitter and the polarizing hologram are used for changing optical paths to be different between a forward route and a backward route or the like in the optical pickup. As the polarizing beam splitter, a pair of prisms sandwiching multilayer film is often used. Moreover, as the polarizing hologram, a birefringent crystal plate such as quartz and calcite that is microprocessed is used. Moreover, for cost reduction, a polymer exhibiting dichroism may be used as the polarizing hologram instead of the crystal plate.

The polarization split element also is constituted of a fine structural body as described above, and the cost reduction has been examined. For example, Non-patent Document 1 reports an optical isolator that utilizes a microprocessing technique. This optical isolator is provided with a diffraction-type polarization split element produced by forming rectangular periodic groove structures on a silica glass at a period that is substantially equal to the wavelength of the light to be used. It is reported that this polarization split element has a characteristic that is sufficient for the practical use.

More specifically, this polarization split element is produced by forming a plurality of grooves that are parallel with one another at equal intervals on the silica glass as the substrate. In this polarization split element, convex portions are provided between the grooves, and these convex portions also are formed periodically. This polarization split element has an aspect ratio of 8 or more and a cross section having a comb-shaped structure with relatively deep grooves. Here, the aspect ratio is represented by a height of the convex portion (hereinafter, called a “grating height”) with respect to a width of the convex portion (hereinafter, called a “grating width”). That is, the aspect ratio is a value obtained by dividing the grating height by the grating width.

The periodic groove structural body having a period that is substantially equal to the wavelength of the light to be used or shorter, which is like the structure of this polarization split element, can control the polarized light beams freely by controlling the grating height and the grating width thereof, and can achieve a higher extinction ratio and a higher diffraction efficiency, thereby having a high performance. Incidentally, in the case of the periodic groove structural body having a period that is longer than the wavelength of the light to be used, the performance thereof is low.

This polarization split element can be produced by only microprocessing the low-cost isotropic glass substrate so as to have a rectangular shape, so a cost reduction can be expected. For example, the microprocessing can be performed by using lithography.

Also, the technical development for forming the periodic groove structure not with an expensive semiconductor process but by press molding has been popular recently. For example, Non-patent Document 2 reports the production of a high-aspect ratio structure of a polymer by press molding that is called a nano imprinting technique. This nano imprinting technique draws attention because its process is simple and a nano-scale microstructure can be formed.

Moreover, for example, Non-patent Document 3 shows an example of characteristics of the polarization split element having such a periodic groove structure.

Non-patent Document 1: Applied Optics, 2002, Vol. 41, No. 18, p. 3558

Non-patent Document 2: Journal of the Japan Society for Precision Engineering, The Japan Society for Precision Engineering, 2004, Vol. 70, No. 10, p. 1223

Non-patent Document 3: J. Opt. A: Pure Appl. Opt. 1, (UK), 1999, p. 215-219

### DISCLOSURE OF INVENTION

### Problem to be Solved by the Invention

In general, the above-described polarization split element having the periodic groove structure with a period that is substantially equal to the wavelength of the light to be used is produced by the semiconductor process. More specifically, by patterning a resist on the substrate with photolithography, electron-beam lithography or the like, and subsequently performing anisotropic etching by dry etching, thereby forming a periodic groove structure on the substrate. However, in order to form a periodic groove structure having a so-called high aspect ratio of, for example, 7 or more, it is necessary to transfer the resist pattern to a metal mask made of a metal with high durability such as Cr and Ni, thereby increasing the number of production steps. Moreover, in the case of etching deeply in a thickness direction of the substrate, it is difficult to prevent side etching, and requires an expensive and large-sized processing apparatus for preventing the side etching. Further, even if forming this periodic groove structure and producing the polarization split element, this polarization split element has a low mechanical strength and is likely to be broken. That is, the polarization split element having the periodic groove structure with the period that is substantially equal to the wavelength of the light to be used exhibits low productivity and thus requires a high cost.

Also, in the case of producing this polarization split element by press molding, it is difficult to form the periodic groove structure having the high aspect ratio, and there are problems in that a pressing time is increased and the structure is broken at the time of being demolded. In the case of using the press molding, a mold is necessary, and the mold has the periodic groove structure with the high aspect ratio. And, the production of the mold requires the use of the semiconductor process, and thus is difficult similarly to the above-described case, so that the cost of the mold is also high. Moreover, the mold has low durability and is difficult to be used repeatedly.

Moreover, the polarization split element having a large grating height with respect to a grating period that is a sum of an interval between the adjacent convex portions and a grating width has an advantage of obtaining a high diffraction efficiency and a disadvantage of increasing the dependence of the diffraction efficiency on an incident angle (see, for example, Hiroshi NISHIHARA, Masamitsu HARUNA and Toshiaki SUHARA, “Optical Integrated Circuit”, revised and enlarged edition, Ohmsha, Ltd., May 20, 2002, p. 83). Since this polarization split element has the diffraction efficiency having the high dependence on the incident angle, the characteristic thereof is degraded when inputting and outputting a beam having an angle component like convergence light by a lens. Moreover, since higher alignment precision of the optical system is required, the number of the production steps is increased.

As described above, in the practical use of the polarization split element that is the diffraction grating obtained by microprocessing the glass, increase of at least one of the aspect ratio and the grating height is a serious problem in productivity and characteristics. Thus, in order to realize the polarization split element with high productivity and preferred characteristics, it is required to have a structure with the aspect ratio and the grating height that are suppressed to be small as much as possible.

The present invention aims to solve the above-described problems in the prior art, and to provide a polarization split element with high productivity and a high performance, a production method thereof, and an optical pickup, an optical device, an optical isolator and a polarizing hologram each of which is provided with the polarization split element.

### Means for Solving Problem

In order to achieve the above-described objects, a first configuration of a polarization split element of the present invention includes a substrate and a plurality of ridge-shaped convex portions provided in parallel with one another at equal intervals on the substrate. Light beam incident to the plurality of convex portions is polarization-split by diffraction. The following conditional expression is satisfied:

1.6≦n≦2.2, and 0.6≦P/λ≦0.8,

where n denotes a refractive index of the convex portion at the wavelength of the incident light beam, P denotes a grating period that is a sum of the interval between the adjacent convex portions and a width of the convex portion, and λ denotes a wavelength of the incident light beam. The incident light beam is split into: a TM polarization zeroth-order diffracted light beam whose magnetic field has a vibration direction that is the same as a length direction of the convex portion; and a TE polarization first-order diffracted light beam whose electric field has a vibration direction that is the same as a length direction of the convex portion.

Moreover, in the above-described first configuration of the polarization split element of the present invention, it is preferable that the following conditional expression is satisfied:

1.8≦n≦2.0, and 0.6≦P/λ≦0.8.

According to the first configuration of the polarization split element of the present invention, the grating height and the aspect ratio can be decreased while maintaining the high performance. Thereby, the small-sized polarization split element that can be produced easily and has a high productivity and a high mechanical strength can be provided.

Moreover, a second configuration of a polarization split element of the present invention includes a substrate and a plurality of ridge-shaped convex portions provided in parallel with one another at equal intervals on the substrate. Light beam incident to the plurality of convex portions is polarization-split by diffraction. The following conditional expression is satisfied:

1.8≦n≦2.4, and 0.6≦P/λ≦1.0,

where n denotes a refractive index of the convex portion with respect to the incident light beam, P denotes a grating period that is a sum of the interval between the adjacent convex portions and a width of the convex portion, and λ denotes a wavelength of the incident light beam. The incident light beam is split into: a TE polarization zeroth-order diffracted light beam whose electric field has a vibration direction that is the same as a length direction of the convex portion; and a TM polarization first-order diffracted light beam whose magnetic field has a vibration direction that is the same as a length direction of the convex portion.

Moreover, in the above-described second configuration of the polarization split element of the present invention, it is preferable that the following conditional expression is satisfied:

1.8≦n≦2.2, and 0.7≦P/λ≦1.0.

According to the second configuration of the polarization split element of the present invention, the grating height and the aspect ratio can be decreased while maintaining the high performance. Thereby, the small-sized polarization split element that can be produced easily and has a high productivity and a high mechanical strength can be provided.

Moreover, a first production method of the polarization split element of the present invention is a production method of the polarization split element of the first or second configuration of the present invention. The method includes press molding a film that is formed on the substrate with a mold having a periodic groove structure.

According to the first production method of the polarization split element of the present invention, since the number of the production steps can be decreased, the cost for producing the polarization split element can be reduced. Moreover, the polarization split element of the present invention has the small grating height and the small aspect ratio, and thus is not broken at the time of being demolded nor takes much time to form a film.

Moreover, a second production method of the polarization split element of the present invention is a production method of the polarization split element of the first or second configuration of the present invention. The method includes forming grooves periodically on a film that is formed on the substrate.

According to the second production method of the polarization split element of the present invention, the polarization split element of the present invention can be produced easily. Moreover, the polarization split element of the present invention has the small grating height, and thus does not take much time to form the film.

Moreover, a configuration of a optical pickup of the present invention includes the first or second configuration of the polarization split element of the present invention.

According to the configuration of the optical pickup of the present invention, since the polarization split element of the first or second configuration of the present invention is included, the small-sized optical pickup with a high performance can be provided at a low cost.

Moreover, in the configuration of the optical pickup of the present invention, it is preferable that the polarization split element performs polarization splitting with respect to a plurality of light beams that have different wavelengths. According to this preferred example, for example, when recording/reproducing a plurality of different optical recording media such as a DVD, a CD and the like, a plurality of the polarization split elements that correspond to the respective optical recording media are not required to be mounted, and one polarization split element can comply with the plurality of the optical recording media. Accordingly, the number of the members of the optical pickup can be reduced.

Moreover, a configuration of a optical device of the present invention includes the first or second configuration of the polarization split element of the present invention.

According to the configuration of the optical device of the present invention, since the first or second configuration of the polarization split element of the present invention is included, the small-sized optical device with a high performance can be provided at a low cost.

Moreover, a configuration of a optical isolator of the present invention includes the first or second configuration of the polarization split element of the present invention.

According to the configuration of the optical isolator of the present invention, since the first or second configuration of the polarization split element of the present invention is included, the small-sized optical isolator with a high performance can be provided at a low cost.

Moreover, a configuration of a polarizing hologram of the present invention includes the first or second configuration of the polarization split element of the present invention.

According to the configuration of the polarizing hologram of the present invention, since the first or second configuration of the polarization split element of the present invention is included, the small-sized polarizing hologram with a high performance can be provided at a low cost.

### EFFECTS OF THE INVENTION

The present invention can provide a polarization split element with high productivity and a high performance, a production method thereof, and an optical pickup, an optical device, an optical isolator and a polarizing hologram each of which is provided with the polarization split element.

### BRIEF DESCRIPTION OF DRAWINGS

FIG. 1 is a perspective view showing a configuration of a polarization split element according to Embodiment 1 of the present invention.

FIG. 2 is a side view of the polarization split element of Embodiment 1 of the present invention for explaining a difference of polarized light beams that are split, FIG. 2(a) shows the polarization split element that splits incident light beam into a TM polarization zeroth-order diffracted light beam and a TE polarization first-order diffracted light beam, and FIG. 2(b) shows the polarization split element that splits the incident light beam into a TE polarization zeroth-order diffracted light beam and a TM polarization first-order diffracted light beam.

FIG. 3 is a graph showing a diffraction efficiency of a conventional first polarization split element in the case where n is 1.47 and P/λ is 0.7, FIG. 3(a) shows a zeroth-order diffraction efficiency of a TM polarized light beam, and FIG. 3(b) shows a first-order diffraction efficiency of a TE polarized light beam.

FIG. 4 is a graph showing a diffraction efficiency of the conventional first polarization split element in the case where n is 1.47 and P/λ is 1.0, FIG. 4(a) shows a zeroth-order diffraction efficiency of a TM polarized light beam, and FIG. 4(b) shows a first-order diffraction efficiency of a TE polarized light beam.

FIG. 5 is a graph showing a diffraction efficiency of the conventional first polarization split element in the case where n is 2.2 and P/λ is 1.0, FIG. 5(a) shows a zeroth-order diffraction efficiency of a TM polarized light beam, and FIG. 5(b) shows a first-order diffraction efficiency of a TE polarized light beam.

FIG. 6 is a graph showing a diffraction efficiency of a first polarization split element of Embodiment 1 of the present invention in the case where n is 2.2 and P/λ is 0.7, FIG. 6(a) shows a zeroth-order diffraction efficiency of a TM polarized light beam, and FIG. 6(b) shows a first-order diffraction efficiency of a TE polarized light beam.

FIG. 7 is a graph showing a relationship between an aspect ratio and a refractive index n of the first polarization split element of Embodiment 1 of the present invention.

FIG. 8 is a graph showing a relationship between a normalized grating height H/λ and the refractive index n of the first polarization split element of Embodiment 1 of the present invention.

FIG. 9 is a graph showing a relationship between a diffraction efficiency and the refractive index n of the first polarization split element of Embodiment 1 of the present invention.

FIG. 10 is a graph showing a diffraction efficiency of a conventional second polarization split element in the case where n is 1.47 and P/λ is 0.7, FIG. 10(a) shows a zeroth-order diffraction efficiency of a TE polarized light beam, and FIG. 10(b) shows a first-order diffraction efficiency of a TM polarized light beam.

FIG. 11 is a graph showing a diffraction efficiency of the conventional second polarization split element in the case where n is 1.47 and P/λ is 1.0, FIG. 11(a) shows a zeroth-order diffraction efficiency of a TE polarized light beam, and FIG. 11(b) shows a first-order diffraction efficiency of a TM polarized light beam.

FIG. 12 is a graph showing a diffraction efficiency of a second polarization split element of Embodiment 1 of the present invention in the case where n is 2.2 and P/λ is 0.7, FIG. 12(a) shows a zeroth-order diffraction efficiency of a TE polarized light beam, and FIG. 12(b) shows a first-order diffraction efficiency of a TM polarized light beam.

FIG. 13 is a graph showing a diffraction efficiency of the second polarization split element of Embodiment 1 of the present invention in the case where n is 2.2 and P/λ is 1.0, FIG. 13(a) shows a zeroth-order diffraction efficiency of a TE polarized light beam, and FIG. 13(b) shows a first-order diffraction efficiency of a TM polarized light beam.

FIG. 14 is a graph showing a relationship between an aspect ratio and a refractive index n of the second polarization split element of Embodiment 1 of the present invention.

FIG. 15 is a graph showing a relationship between a normalized grating height H/λ and the refractive index n of the second polarization split element of Embodiment 1 of the present invention.

FIG. 16 is a graph showing a relationship between a diffraction efficiency and the refractive index n of the second polarization split element of Embodiment 1 of the present invention.

FIG. 17 shows cross-sectional views illustrating steps in a production method of the polarization split element of Embodiment 1 of the present invention.

FIG. 18 shows cross-sectional views illustrating steps in a production method of the polarization split element of Embodiment 1 of the present invention by using a mold.

FIG. 19 is a schematic view showing a configuration of an optical pickup of Embodiment 2 of the present invention.

FIG. 20 is a graph showing dependence of the diffraction efficiency on an incident angle and a wavelength changing amount in a polarizing beam splitter (PBS) used in the optical pickup of Embodiment 2 of the present invention, FIG. 20(a) shows a first-order diffraction efficiency of a TE polarized light beam, and FIG. 20(b) shows a zeroth-order diffraction efficiency of a TM polarized light beam.

FIG. 21 is a graph showing dependence of a diffraction efficiency on an incident angle and a wavelength changing amount in a conventional polarization split element used in the optical pickup, FIG. 21(a) shows a first-order diffraction efficiency of a TE polarized light beam, and FIG. 21(b) shows a zeroth-order diffraction efficiency of a TM polarized light beam.

FIG. 22 is a schematic view showing a configuration of an optical isolator of Embodiment 3 of the present invention.

FIG. 23 is a schematic view showing a configuration of a polarizing hologram of Embodiment 3 of the present invention.

### BEST MODE FOR CARRYING OUT THE INVENTION

The present invention will be described below more specifically by way of embodiments.

### Embodiment 1

Firstly, a polarization split element of Embodiment 1 of the present invention will be described with reference to the drawings. Incidentally, the polarization split element of Embodiment 1 performs polarization splitting with respect to an incident light beam by diffraction.

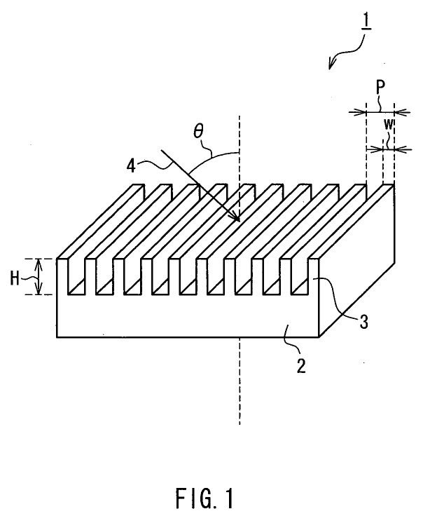

FIG. 1 is a perspective view showing a configuration of the polarization split element according to Embodiment 1 of the present invention. As shown in FIG. 1, the polarization split element 1 of Embodiment 1 is made of a transparent material, and has a periodic concavo-convex structure. Here, the period of the concavo-convex structure is set to be substantially equal to a wavelength of light to be used or less. And, the polarization split element 1 has a function of splitting polarized light beam into a zeroth-order diffracted light beam and a first-order diffracted light beam.

More specifically, the polarization split element 1 of Embodiment 1 includes a substrate 2 and a plurality of ridge-shaped convex portions 3 formed perpendicularly to a surface of the substrate 2 on the substrate 2. Here, the plurality of the convex portions 3 are provided in parallel with one another at equal intervals. That is, the polarization split element 1 has a periodic groove structure.

Respective dimensions of the polarization split element 1 are represented as shown in FIG. 1. More specifically, a grating width that is a width of the convex portion 3 is represented by w, a grating height that is a height of the convex portion 3 is represented by H, and a grating period that is a sum of the interval between the adjacent convex portions 3 and the grating width w is represented by P. The polarization split element 1 is designed with a wavelength λ of an incident light beam 4 that is incident to the plurality of the convex portions 3, a refractive index n of the convex portion 3 with respect to the light beam with the wavelength λ, an incident angle θ of the incident light beam 4, a polarization of the incident light beam 4 and the like as parameters, besides the above-described dimensions of the grating width w, the grating height H and the grating period P. Here, the incident angle θ is an angle between a direction that is perpendicular to a surface of the substrate 2 and an incident direction of the incident light beam 4, and the polarization is either TE polarization or TM polarization. In the polarization split element 1 of Embodiment 1, the refractive index n is 1.6 or more. Moreover, a refractive index of the substrate 2 is 1.47. Incidentally, a ratio of the grating width w with respect to the grating period P is represented by a duty ratio.

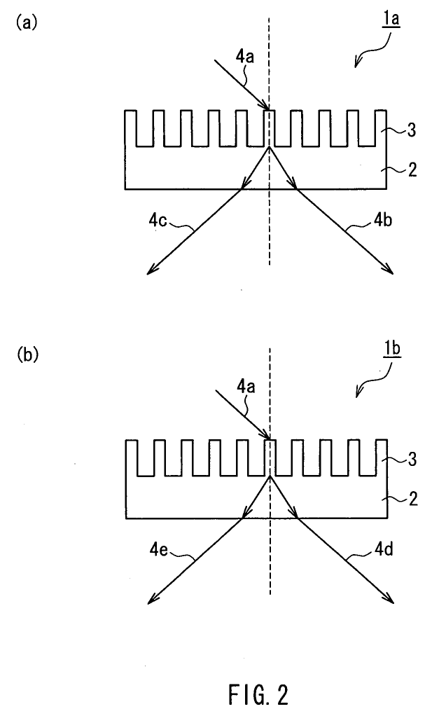

Elements that split polarized light beam by diffraction such as the polarization split element 1 are classified into two kinds according to a difference of the polarized light beams that are split. FIG. 2 is a side view of the polarization split element for explaining a difference of polarized light beams that are split, FIG. 2(a) shows the polarization split element that splits incident light beam into a TM polarization zeroth-order diffracted light beam and a TE polarization first-order diffracted light beam, and FIG. 2(b) shows the polarization split element that splits the incident light beam into a TE polarization zeroth-order diffracted light beam and a TM polarization first-order diffracted light beam. Here, the TE polarized light beam is a polarized light beam whose electric field has a vibration direction that is perpendicular to an incident plane, and the TM polarized light beam is a polarized light beam whose electric field has a vibration direction that is parallel with the incident plane. In addition, the incident plane is a surface that is parallel with the sheet of FIG. 2. That is, the TE polarized light beam is a polarized light beam whose electric field has a vibration direction that is the same as a length direction of the convex portion 3, and the TM polarized light beam is a polarized light beam whose magnetic field has a vibration direction that is the same as the length direction of the convex portion 3.

Hereinafter, the polarization split element shown in FIG. 2(a) is represented as a first polarization split element 1a, and the polarization split element shown in FIG. 2(b) is represented as a second polarization split element 1b. The first polarization split element 1a and the second polarization split element 1b have the same shapes as that of the polarization split element 1 shown in FIG. 1. Thus, respective members of the first polarization split element 1a and the second polarization split element 1b that correspond to the respective members of the polarization split element 1 shown in FIG. 1 are denoted by the same reference numerals, and the explanations thereof will be omitted. Incidentally, the polarization split element 1 can be used also as the first polarization split element 1a or the second polarization split element 1b by adjusting its grating height H and its duty ratio.

For example, in the case of using the polarization split element 1 as the first polarization split element 1a, it is required to satisfy the conditions described below. Here, the conditions to be satisfied will be shown, with parameters of a normalized grating height H/λ that is obtained by normalizing the grating height H by the wavelength λ of the incident light beam, and a duty ratio w/P that is a ratio of the grating width w with respect to the grating period P.

0.16<w/P<0.40

0.5<H/λ<1.1

Moreover, in the case of using the polarization split element 1 as the second polarization split element 1b, it is required to satisfy conditions described below.

0.28<w/P<0.50

0.9<H/λ<1.8

As described above, a difference between the first polarization split element 1a and the second polarization split element 1b lies in that the normalized grating height H/λ of the second polarization split element 1b is almost twice the normalized grating height H/λ of the first polarization split element 1a. Incidentally, since the duty ratio w/P is also increased in proportion to the normalized grating height H/λ, the aspect ratio of the first polarization split element 1a is not much different from the aspect ratio of the second polarization split element 1b.

And, the polarization split element 1 (the first polarization split element 1a or the second polarization split element 1b) that has the periodic groove structure with a period that is substantially equal to or less than the wavelength of the light to be used can control the polarized light beam freely and realize a still higher extinction ratio and a still higher diffraction efficiency by controlling its grating height and its grating width, thereby achieving a high performance.

In the first polarization split element 1a shown in FIG. 2(a), an incident light beam 4a including a TE polarized light beam and a TM polarized light beam mixed, which is incident from the convex portion 3 side of the first polarization split element 1a, is split into a TM polarized light beam 4b that is a zeroth-order diffracted light beam and a TE polarized light beam 4c that is a first-order diffracted light beam by the first polarization split element 1a that is a diffraction grating. An electric field of the TE polarized light beam 4c vibrates in a direction perpendicular to the sheet (incident plane) of FIG. 2(a). And, an electric field of the TM polarized light beam 4b vibrates in a direction that is parallel with the sheet (incident plane) of FIG. 2(a) and is perpendicular to a traveling direction of the light beam. Incidentally, the first polarization split element 1a outputs a TE polarization zeroth-order diffracted light beam and a TM polarization first-order diffracted light beam slightly, besides the TM polarized light beam 4b that is the zeroth-order diffracted light beam and the TE polarized light beam 4c that is the first-order diffracted light beam.

Moreover, this first polarization split element 1a satisfies the conditions described below.

1.6≦n≦2.2, and 0.6≦P/λ≦0.8.

Also, this first polarization split element 1a preferably satisfies the conditions described below.

1.8≦n≦2.0, and 0.6≦P/λ≦0.8.

According to the configuration of this first polarization split element 1a, the grating height and the aspect ratio can be decreased while maintaining the high performance. Thereby, the small-sized polarization split element that can be produced easily and has a high productivity and a high mechanical strength can be provided at a low cost. Moreover, since a value of the grating height H can be small, dependence of the diffraction efficiency on an incident angle also can be small.

Moreover, in the second polarization split element 1b shown in FIG. 2(b), the incident light beam 4a including the TE polarized light beam and the TM polarized light beam mixed, which is incident from the convex portion 3 side of the second polarization split element 1b, is split into a TE polarized light beam 4d that is a zeroth-order diffracted light beam and a TM polarized light beam 4e that is a first-order diffracted light beam by the second polarization split element 1b that-is a diffraction grating. An electric field of the TE polarized light beam 4d vibrates in a direction perpendicular to the sheet (incident plane) of FIG. 2(b). And, an electric field of the TM polarized light beam 4e vibrates in a direction that is parallel with the sheet (incident plane) of FIG. 2(b) and is perpendicular to a traveling direction of the light beam. Incidentally, the second polarization split element 1b outputs a TM polarization zeroth-order diffracted light beam and a TE polarization first-order diffracted light beam slightly, besides the TE polarized light beam 4d that is the zeroth-order diffracted light beam and the TM polarized light beam 4e that is the first-order diffracted light beam.

Moreover, this second polarization split element 1b satisfies the conditions described below.

1.8≦n≦2.4, and 0.6≦P/λ≦1.0.

Also, this second polarization split element 1b preferably satisfies the conditions described below.

1.8≦n≦2.2, and 0.7≦P/λ≦1.0.

According to the configuration of this second polarization split element 1b, the grating height and the aspect ratio can be decreased while maintaining the high performance. Thereby, the small-sized polarization split element that can be produced easily and has a high productivity and a high mechanical strength can be provided at a low cost. Moreover, since a value of the grating height H can be small, dependence of the diffraction efficiency on an incident angle also can be small.

The first polarization split element 1a of FIG. 2(a) is preferably designed such that the first-order diffraction efficiency of the TE polarized light beam and the zeroth-order diffraction efficiency of the TM polarized light beam can be high, so as to split the incident light beams 4a into the TM polarized light beam 4b that is the zeroth-order diffracted light beam and the TE polarized light beam 4c that is the first-order diffracted light beam. Moreover, the second polarization split element 1b of FIG. 2(b) is preferably designed such that the zeroth-order diffraction efficiency of the TE polarized light beam and the first-order diffraction efficiency of the TM polarized light beam can be high, so as to split the incident light beams 4a into the TE polarized light beam 4d that is the zeroth-order diffracted light beam and the TM polarized light beam 4e that is the first-order diffracted light beam. Thereby, the performances of the first polarization split element 1a and the second polarization split element 1b can be improved.

Next, characteristics of the first polarization split element 1a and the second polarization split element 1b of Embodiment 1 shown in FIG. 2 were evaluated by calculation. Incidentally, for the calculation of the characteristics of the polarization split elements, a calculation software “GSOLVER” using a RCWA (Rigorous Coupled Wave Analysis) method, which is produced by Grating Solver Development Company in the U.S. was used. For propagation analysis of light in the periodical groove structural body, like the polarization split element of the present invention, which has the period that is substantially equal to or less than the wavelength of the light to be used, not a conventional analysis like ray tracing in a scalar region but a calculation technique for analyzing numerically is applied. The RCWA method is a representative calculation technique for obtaining such a numerical solution.

Firstly, the characteristic of the first polarization split element 1a shown in FIG. 2(a) was obtained by the calculation.

Here shows, for comparison, calculation results of a characteristic of a conventional polarization split element (hereinafter, called a “conventional first polarization split element”) that has a structure similar to that of the first polarization split element 1a of Embodiment 1 but does not satisfy conditions:

1.6≦n≦2.2, and 0.6≦P/λ≦0.8.

The conventional first polarization split element has a shape similar to that of the first polarization split element 1a shown in FIG. 2(a), but its convex portion is made of silica that is a low-refractive-index material, so that the above-described conditions are not satisfied, and the calculation results are different from those of the first polarization split element 1a. Incidentally, the low-refractive-index material generally means a material whose refractive index is less than 1.6. Assuming the case of using visible light, it was calculated with a refractive index of the silica of 1.47 in the cases where the incident angle θ was 30° and 45°. The grating period P was normalized by the wavelength λ of the light to be used so as to conform substantially to Bragg conditions in the respective cases. More specifically, in the case where the incident angle θ was 30°, the normalized grating period P/λ was 1.0, and in the case where the incident angle θ was 45°, the normalized grating period P/λ was 0.7.

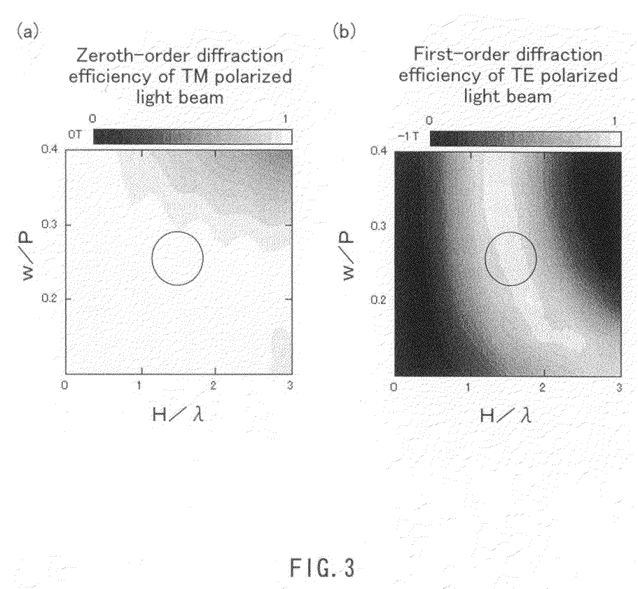

The light was incident from a side of air whose refractive index was 1, and a diffraction efficiency inside the substrate 2 was calculated without considering a Fresnel reflection on a rear surface of the substrate 2. FIG. 3 is a graph showing a diffraction efficiency of the conventional first polarization split element in the case where n is 1.47 and P/λ is 0.7, FIG. 3(a) shows a zeroth-order diffraction efficiency of a TM polarized light beam, and FIG. 3(b) shows a first-order diffraction efficiency of a TE polarized light beam.

In FIGS. 3(a) and 3(b), a horizontal axis represents the normalized grating height H/λ obtained by normalizing the grating height H by the wavelength λ of the light to be used, a vertical axis represents a duty ratio w/P that is a ratio of the grating width w with respect to the grating period P, and the diffraction efficiency in the case of changing them continuously is mapped with contour lines. In the figure, the diffraction efficiency is shown by a grey scale where a color of black to white represents 0% to 100%, respectively. That is, a position in a color closer to white exhibits a higher diffraction efficiency.

As is realized from FIG. 3, each of the diffraction efficiencies (the zeroth-order diffraction efficiency of the TM polarized light beam and the first-order diffraction efficiency of the TE polarized light beam) depends on the normalized grating height H/λ and the duty ratio w/P, and changes periodically. The conventional first polarization split element is required to have a structure in which both of the zeroth-order diffraction efficiency of the TM polarized light beam and the first-order diffraction efficiency of the TE polarized light beam are high. Moreover, for obtaining the structure that can be produced easily, it is preferable to set the normalized grating height H/λ to be small and the duty ratio w/P to be large.

Moreover, as is realized from FIG. 3, in the case where the normalized grating period P/λ is 0.7, both of the zeroth-order diffraction efficiency of the TM polarized light beam and the first-order diffraction efficiency of the TE polarized light beam are high when H/λ is in a range from about 1.3 to about 2.0 and w/P is in a range from about 0.2 to about 0.3. More specifically, in FIGS. 3(a) and 3(b), a range in which both of the zeroth-order diffraction efficiency of the TM polarized light beam and the first-order diffraction efficiency of the TE polarized light beam are high (80% or more) is marked with a circle. The conventional first polarization split element is required to be produced such that the normalized grating height H/λ and the duty ratio w/P are in this range.

An example of the structure and the characteristic of the conventional first polarization split element in this range will be shown below.

Refractive index n: 1.47

Normalized grating period P/λ: 0.7

Incident angle θ: 45°

Normalized grating height H/λ: 1.46

Duty ratio w/P: 0.27

Aspect ratio: 7.7

First-order diffraction efficiency of TE polarized light beam: 92.0%

Zeroth-order diffraction efficiency of TM polarized light beam: 96.4%

Zeroth-order diffraction efficiency of TE polarized light beam: 0.19%

First-order diffraction efficiency of TM polarized light beam: 0.66%

Extinction ratio on first-order side: 21 dB

Extinction ratio on zeroth-order side: 27 dB

Incidentally, the extinction ratio is calculated by formulae described below. Here, the extinction ratio is a ratio between an intensity of a necessary polarized light beam and an intensity of an unnecessary polarized light beam, and represented by decibel (dB).

Extinction ratio on first-order side=10×log₁₀(first-order diffraction efficiency of TE polarized light beam/first-order diffraction efficiency of TM polarized light beam)

Extinction ratio on zeroth-order side=10×log₁₀(zeroth-order diffraction efficiency of TM polarized light beam/zeroth-order diffraction efficiency of TE polarized light beam)

As is realized from the above results, in the case of producing the polarization split element by using the low-refractive index material such as silica, in order to obtain the diffraction efficiency and the extinction ratio for exhibiting a sufficient polarization property, the grating height H and the aspect ratio are required to be extremely high. Thus, such a polarization split element has a low mechanical strength and is difficult to be produced.

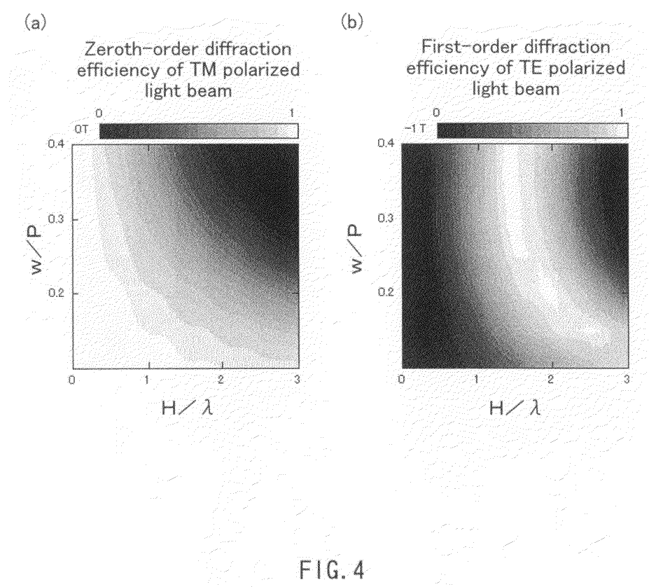

Moreover, FIG. 4 is a graph showing a diffraction efficiency of the conventional first polarization split element in the case where n is 1.47 and P/λ is 1.0, FIG. 4(a) shows a zeroth-order diffraction efficiency of a TM polarized light beam, and FIG. 4(b) shows a first-order diffraction efficiency of a TE polarized light beam. That is, FIG. 4 is a graph showing the respective diffractive efficiencies (the zeroth-order diffraction efficiency of the TM polarized light beam and the first-order diffraction efficiency of the TE polarized light beam) in the case where the normalized grating period P/λ is different from that of FIG. 3.

In FIG. 4, there is no range in which both of the zeroth-order diffraction efficiency of the TM polarized light beam and the first-order diffraction efficiency of the TE polarized light beam were 80% or more. There is a possibility to obtain such characteristics if setting the grating height H to be still larger, but the aspect ratio in this case becomes an unrealistic value for producing the polarization split element. Thus, in the case where P/λ is 1.0, it is not possible to produce a polarization split element that can be used actually.

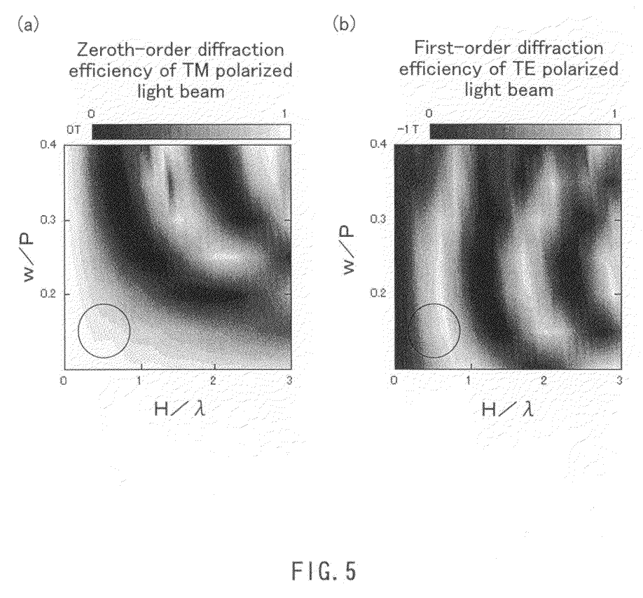

Moreover, FIG. 5 is a graph showing a diffraction efficiency of the conventional first polarization split element in the case where n is 2.2 and P/λ is 1.0, FIG. 5(a) shows a zeroth-order diffraction efficiency of a TM polarized light beam, and FIG. 5(b) shows a first-order diffraction efficiency of a TE polarized light beam.

By comparing FIG. 5 with FIG. 4, the dependence of the diffraction efficiencies on the duty ratios w/P and the normalized grating heights H/λ are different.

Moreover, as is realized from FIG. 5, in the case where the normalized grating period P/λ is 1.0, both of the zeroth-order diffraction efficiency of the TM polarized light beam and the first-order diffraction efficiency of the TE polarized light beam become high when H/λ is about 0.8 and w/P is about 0.1. More specifically, in FIGS. 5(a) and 5(b), a range in which both of the zeroth-order diffraction efficiency of the TM polarized light beam and the first-order diffraction efficiency of the TE polarized light beam are high is marked with a circle. In the case where the normalized grating period P/λ is 1.0, the conventional first polarization split element is required to be produced such that the normalized grating height H/λ and the duty ratio w/P are in this range.

An example of the structure and the characteristic of the conventional first polarization split element in this range will be shown below.

Refractive index n: 2.2

Normalized grating period P/λ: 1.0

Incident angle θ: 30°

Normalized grating height H/λ: 0.88

Duty ratio w/P: 0.10

Aspect ratio: 8.8

First-order diffraction efficiency of TE polarized light beam: 94.2%

Zeroth-order diffraction efficiency of TM polarized light beam: 96.2%

Zeroth-order diffraction efficiency of TE polarized light beam: 0.73%

First-order diffraction efficiency of TM polarized light beam: 0.78%

Extinction ratio on first-order side: 21 dB

Extinction ratio on zeroth-order side: 21 dB

As is realized from the above-described results, even when 1.6≦n≦2.2, which is one of the conditions of the first polarization split element 1a of Embodiment 1 is satisfied, if 0.6≦P/λ≦0.8 is not satisfied, the grating height H and the aspect ratio become significantly high in order to obtain the diffraction efficiency and the extinction ratio for exhibiting the sufficient polarization property. And, such a polarization split element has a low mechanical strength and is difficult to be produced. Thus, in the case where P/λ is 1.0, if n is 1.47, a polarization split element that can be used practically cannot be produced. Also, even if n is 2.2, the aspect ratio becomes too high, such that a polarization split element that can be used practically cannot be produced.

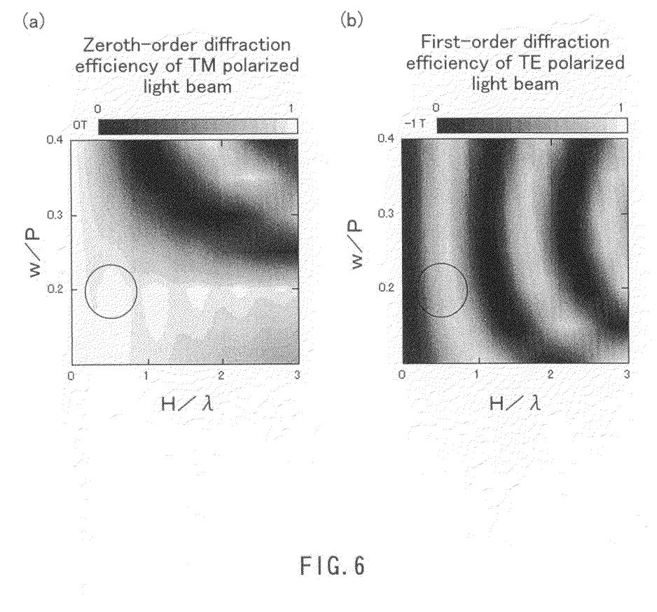

Next, calculation results of the characteristic of the first polarization split element 1a of Embodiment 1 will be shown. More specifically, the first polarization split element 1a of Embodiment 1 has a structure shown in FIG. 2(a), which is set to have a refractive index n of 2.2, and a normalized grating period P/λ of 0.7. FIG. 6 is a graph showing a diffraction efficiency of the first polarization split element of Embodiment 1 of the present invention in the case where n is 2.2 and P/λ is 0.7, FIG. 6(a) shows a zeroth-order diffraction efficiency of a TM polarized light beam, and FIG. 6(b) shows a first-order diffraction efficiency of a TE polarized light beam.

In FIGS. 6(a) and 6(b), a horizontal axis represents the normalized grating height H/λ obtained by normalizing the grating height H by the wavelength λ of the light to be used, a vertical axis represents a duty ratio w/P that is a ratio of the grating width w with respect to the grating period P, and the diffraction efficiency in the case of changing them continuously is mapped with contour lines. In the figure, the diffraction efficiency is shown by a grey scale where a color of black to white represents 0% to 100%, respectively. That is, a position in a color closer to white exhibits a higher diffraction efficiency.

By comparing FIG. 6 with FIG. 3, the dependence of the diffraction efficiencies on the duty ratios w/P and the normalized grating heights H/λ are different. The first polarization split element 1a of Embodiment 1 has a shorter period of a change of the diffraction efficiency with respect to changes of the duty ratio w/P and the normalized grating height H/λ than that of the conventional first polarization split element. That is, compared with the conventional first polarization split element, the first polarization split element 1a of Embodiment 1 can achieve the high diffraction efficiency with a smaller grating height H.

As is realized from FIG. 6, in the first polarization split element 1a, in the case where the normalized grating period P/λ is 0.7, both of the zeroth-order diffraction efficiency of the TM polarized light beam and the first-order diffraction efficiency of the TE polarized light beam become high when H/λ is about 0.6 and w/P is about 0.2. More specifically, in FIGS. 6(a) and 6(b), a range in which both of the zeroth-order diffraction efficiency of the TM polarized light beam and the first-order diffraction efficiency of the TE polarized light beam are high is marked with a circle. In the case where the normalized grating period P/λ is 0.7, the first polarization split element 1a is required to be produced such that the normalized grating height H/λ and the duty ratio w/P are in this range.

An example of the structure and the characteristic of the first polarization split element 1a of Embodiment 1 in this range will be shown below.

Refractive index n: 2.2

Normalized grating period P/λ: 0.7

Incident angle θ: 45°

Normalized grating height H/λ: 0.6

Duty ratio w/P: 0.21

Aspect ratio: 4.1

First-order diffraction efficiency of TE polarized light beam: 89.6%

Zeroth-order diffraction efficiency of TM polarized light beam: 97.9%

Zeroth-order diffraction efficiency of TE polarized light beam: 0.04%

First-order diffraction efficiency of TM polarized light beam: 0.70%

Extinction ratio on first-order side: 21 dB

Extinction ratio on zeroth-order side: 34 dB

As is realized from the above-described results, in the case where P/λ is 0.7, the first polarization split element 1a of Embodiment 1 with the refractive index n of 2.2 has the grating height H that is decreased by about 59% and the aspect ratio that is lower by about 47%, compared with those of the conventional first polarization split element (see FIG. 3) with the refractive index n of 1.47.

As described above, the first polarization split element 1a of Embodiment 1 has a favorable characteristic. Moreover, as described above, the grating height H and the aspect ratio of the first polarization split element with the favorable characteristic depend on the refractive index n. Further, since the grating height H and the aspect ratio of the first polarization split element 1a with the favorable characteristic also depend largely on the grating period P, the grating period P also is required to have an optimal value.

Here, in the first polarization split element 1a with the structure shown in FIG. 2(a), while setting the normalized grating period P/λ to have four values of 0.6, 0.7, 0.8 and 1.0, and varying the refractive index n in a range from 1.5 to 2.6 respectively, the aspect ratio, the normalized grating height H/λ and the first-order diffraction efficiency of the TE polarized light beam were measured. Incidentally, the incident angle θ was set to be a Bragg angle (θ=sin⁻¹(λ/2P)) that can provide a high diffraction efficiency. Moreover, the first polarization split element 1a was designed such that the zeroth-order diffraction efficiency of the TE polarized light beam with respect to the zeroth-order diffraction efficiency of the TM polarized light beam was about 1% or less (the extinction ratio was about 20 dB), and the first-order diffraction efficiency of the TM polarized light beam with respect to the first-order diffraction efficiency of the TE polarized light beam was about 1% or less. Since the incident angle became significantly large when P/λ was 0.6 (the Bragg angle was 56.4°), a reflection loss was generated, thereby resulting in the decrease of the diffraction efficiency of the TE polarized light beam. Thus, the grating period less than this value is not preferred.

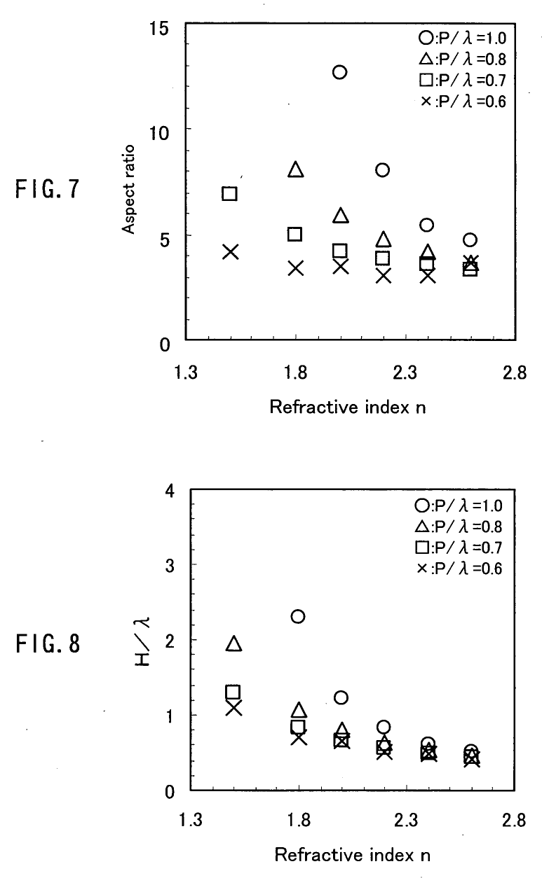

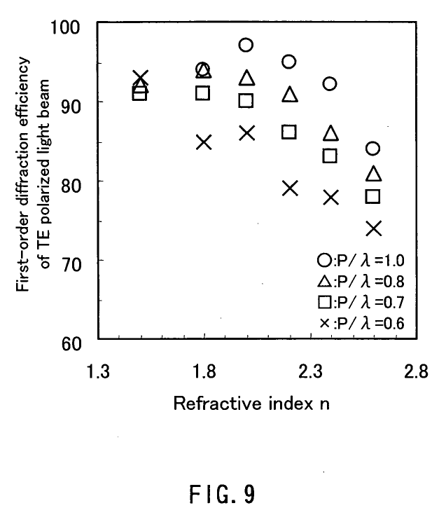

Measurement results thereof will be shown in FIGS. 7, 8 and 9. FIG. 7 is a graph showing a relationship between the aspect ratio and the refractive index n of the first polarization split element 1a. FIG. 8 is a graph showing a relationship between the normalized grating height H/λ and the refractive index n of the first polarization split element 1a. FIG. 9 is a graph showing a relationship between the diffraction efficiency (first-order diffraction efficiency of the TE polarized light beam) and the refractive index n of the first polarization split element 1a. Incidentally, in the respective figures, “x” denotes the case where P/λ is 0.6, “□” denotes the case where P/λ is 0.7, “Δ” denotes the case where P/λ is 0.8, and “o” denotes the case where P/λ is 1.0.

The following can be understood from FIG. 7. Firstly, the aspect ratio is decreased with the increase of the refractive index n, regardless of the value of the normalized grating period P/λ. Moreover, the dependence of the aspect ratio on the refractive index is high when P/λ is 0.8 or more, and the aspect ratio is increased steeply with the decrease of the refractive index n. Further, when P/λ is less than 0.8 and n is 1.8 or more, the aspect ratio is about 5 or less. Moreover, the dependence of the aspect ratio on the refractive index becomes smaller with the decrease of the normalized grating period P/λ, and when P/λ is 0.6, the aspect ratio is substantially constant regardless of a value of the refractive index n.

Also, the following can be understood from FIG. 8. Firstly, the normalized grating height H/λ is decreased with the increase of the refractive index n regardless of a value of the normalized grating period P/λ. Moreover, the normalized grating height H/λ is decreased with the decrease of the normalized grating period P/λ. Further, when P/λ is 1.0, in the case where n is 2.0 or less, the normalized grating height H/λ is increased steeply with the decrease of the refractive index n. Moreover, when P/λ is 0.8 or less, the dependence of the normalized grating height H/λ on the normalized grating period P/λ is relatively small, and when n is 1.8 or more, the normalized grating height H/λ is about 1 or less.

Moreover, it can be realized from FIG. 9 as follows. Firstly, when the refractive index n is 2.0 or less, the diffraction efficiency continues to be high substantially constantly, but when the refractive index n is larger than 2.0, the diffraction efficiency starts to be decreased. Further, when P/λ is 0.6, the diffraction efficiency tends to be small.

From the facts described above, it is realized that the normalized grating height H/λ and the aspect ratio can be decreased significantly by setting the refractive index n to be high.

As described above, the range of the refractive index n and the normalized grating period P/λ of the first polarization split element 1a of Embodiment 1 is:

1.6≦n≦2.2, and 0.6≦P/λ≦0.8.

From FIGS. 7, 8 and 9, it can be realized that the first polarization split element 1a of Embodiment 1 can suppress the aspect ratio to be about 6 or less and the grating height to be about 1λ or less while maintaining the high diffraction efficiency. Accordingly, the first polarization split element 1a can be produced easily while maintaining its high performance.

Further, as described above, the refractive index n and the normalized grating period P/λ of the first polarization split element 1a of Embodiment 1 are particularly preferably in a range described below.

1.8≦n≦2.0, and 0.6≦P/λ≦0.8.

By setting the refractive index n and the normalized grating period P/λ to be in this range, the aspect ratio can be suppressed to be about 4 or less while maintaining the still higher diffraction efficiency.

As described above, according to the configuration of the first polarization split element 1a of Embodiment 1, since the grating height and the aspect ratio can be decreased while maintaining the high performance, a small-sized polarization split element that can be produced easily and has high productivity and a high mechanical strength can be provided.

Next, a characteristic of the second polarization split element 1b shown in FIG. 2(b) was obtained by the calculation similarly to that of the above-described first polarization split element 1a.

Here is shown, for comparison, calculation results of a characteristic of a conventional polarization split element (hereinafter, called a “conventional second polarization split element”) that has a structure similar to that of the second polarization split element 1b of Embodiment 1 but does not satisfy the conditions:

1.8≦n≦2.4, and 0.6≦P/λ≦1.0.

The conventional second polarization split element has a shape similar to that of the second polarization split element 1b shown in FIG. 2(b), but its convex portion is made of silica that is a low-refractive-index material, so that the above-described conditions are not satisfied, and the calculation results are different from those of the second polarization split element 1b. Assuming the case of using visible light, it was calculated with a refractive index of the silica of 1.47 in the cases where the incident angle θ was 30° and 45°. The grating period P was normalized by the wavelength λ of the light to be used so as to conform substantially to Bragg conditions in the respective cases. More specifically, in the case where the incident angle θ was 30°, the normalized grating period P/λ was 1.0, and in the case where the incident angle θ was 45°, the normalized grating period P/λ was 0.7.

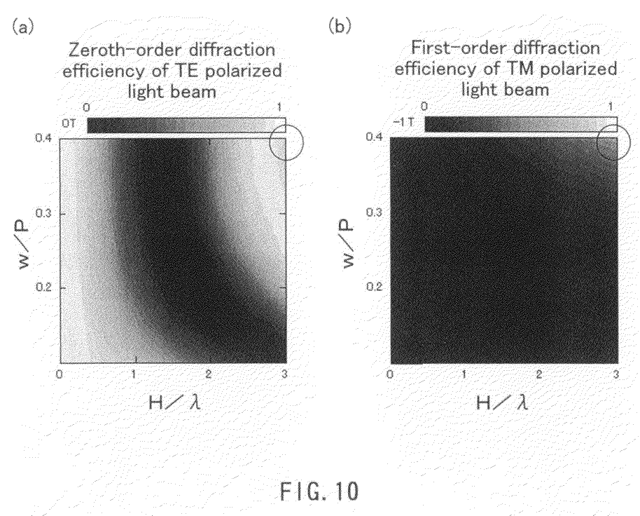

The light was incident from a side of air whose refractive index was 1, and a diffraction efficiency inside the substrate 2 was calculated without considering a Fresnel reflection on a rear surface of the substrate 2. FIG. 10 is a graph showing a diffraction efficiency of the conventional second polarization split element in the case where n is 1.47 and P/λ is 0.7, FIG. 10(a) shows a zeroth-order diffraction efficiency of a TE polarized light beam, and FIG. 10(b) shows a first-order diffraction efficiency of a TM polarized light beam.

In FIGS. 10(a) and 10(b), a horizontal axis represents the normalized grating height H/λ obtained by normalizing the grating height H by the wavelength λ of the light to be used, a vertical axis represents a duty ratio w/P that is a ratio of the grating width w with respect to the grating period P, and the diffraction efficiency in the case of changing them continuously is mapped with contour lines. In the figure, the diffraction efficiency is shown by a grey scale where a color of black to white represents 0% to 100%, respectively. That is, a position in a color closer to white exhibits a higher diffraction efficiency.

As is realized from FIG. 10, similarly to FIGS. 3 to 6, each of the diffraction efficiencies (the zeroth-order diffraction efficiency of the TE polarized light beam and the first-order diffraction efficiency of the TM polarized light beam) depends on the normalized grating height H/λ and the duty ratio w/P, and changes periodically. For obtaining a polarization split function, it is required to adopt a structure that both of the zeroth-order diffraction efficiency of the TE polarized light beam and the first-order diffraction efficiency of the TM polarized light beam are high. Moreover, for obtaining the structure that can be produced easily, it is preferable to set the normalized grating height H/λ to be small and the duty ratio w/P to be large.

In FIGS. 10(a) and 10(b), a range in which both of the zeroth-order diffraction efficiency of the TE polarized light beam and the first-order diffraction efficiency of the TM polarized light beam are high is marked with a circle.

An example of the structure and the characteristic of the conventional second polarization split element in this range will be shown below.

Refractive index n: 1.47

Normalized grating period P/λ: 0.7

Incident angle θ: 45°

Normalized grating height H/λ: 3.1

Duty ratio w/P: 0.57

Aspect ratio: 7.8

Zeroth-order diffraction efficiency of TE polarized light beam: 94.7%

First-order diffraction efficiency of TM polarized light beam: 98.8%

First-order diffraction efficiency of TE polarized light beam: 0.20%

Zeroth-order diffraction efficiency of TM polarized light beam: 0.39%

Extinction ratio on first-order side: 27 dB

Extinction ratio on zeroth-order side: 27 dB

Incidentally, the extinction ratio is calculated by formulae described below.

Extinction ratio on first-order side=10×log₁₀(first-order diffraction efficiency of TM polarized light beam/first-order diffraction efficiency of TE polarized light beam)

Extinction ratio on zeroth-order side=10×log₁₀(zeroth-order diffraction efficiency of TE polarized light beam/zeroth-order diffraction efficiency of TM polarized light beam)

As is realized from the above results, in the case of producing the polarization split element by using the low-refractive index material such as silica, in order to obtain the diffraction efficiency and the extinction ratio for exhibiting a sufficient polarization property, the grating height H and the aspect ratio are required to be extremely high. Thus, such a polarization split element has a low mechanical strength and is difficult to produce.

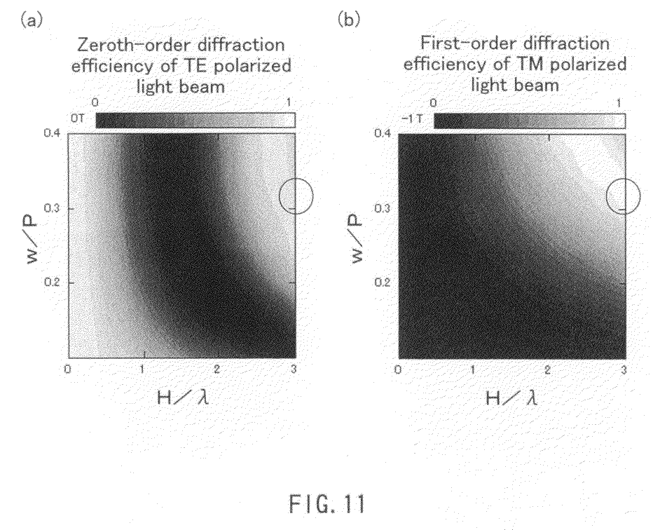

Moreover, FIG. 11 is a graph showing a diffraction efficiency of the conventional second polarization split element in the case where n is 1.47 and P/λ is 1.0, FIG. 11(a) shows a zeroth-order diffraction efficiency of a TE polarized light beam, and FIG. 11(b) shows a first-order diffraction efficiency of a TM polarized light beam. That is, FIG. 11 is a graph showing the respective diffraction efficiencies (the zeroth-order diffraction efficiency of a TE polarized light beam and the first-order diffraction efficiency of the TM polarized light beam) in the case where the normalized grating period P/λ is different from that of FIG. 10.

In FIGS. 11(a) and 11(b), a range in which both of the zeroth-order diffraction efficiency of a TE polarized light beam and the first-order diffraction efficiency of the TM polarized light beam are high is marked with a circle.

An example of the structure and the characteristic of the conventional second polarization split element in this range will be shown below.

Refractive index n: 1.47

Normalized grating period P/λ: 1.0

Incident angle θ: 30°

Normalized grating height H/λ: 2.9

Duty ratio w/P: 0.34

Aspect ratio: 8.5

Zeroth-order diffraction efficiency of TE polarized light beam: 95.9%

First-order diffraction efficiency of TM polarized light beam: 97.4%

First-order diffraction efficiency of TE polarized light beam: 0.98%

Zeroth-order diffraction efficiency of TM polarized light beam: 0.32%

Extinction ratio on first-order side: 20 dB

Extinction ratio on zeroth-order side: 25 dB

As is realized from the above results, in the case of producing the polarization split element by using the low-refractive index material such as silica, in order to obtain the diffraction efficiency and the extinction ratio for exhibiting a sufficient polarization property, the grating height H and the aspect ratio is required to be extremely high. Thus, such a polarization split element has a low mechanical strength and is difficult to produce.

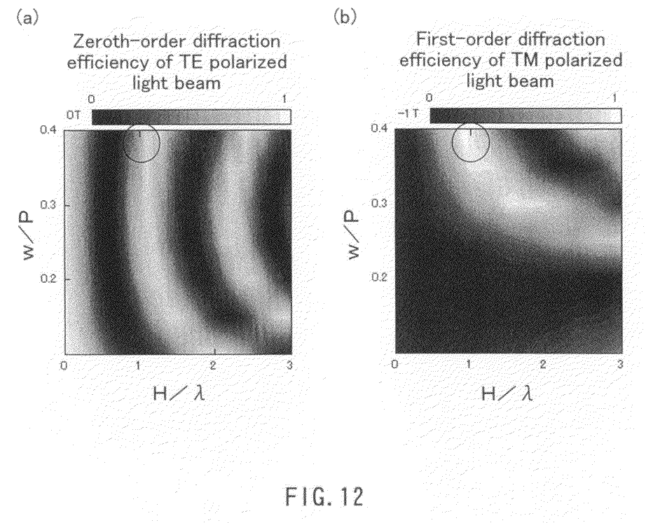

Next, calculation results of the characteristic of the second polarization split element 1b of Embodiment 1 will be shown. More specifically, the second polarization split element 1b of Embodiment 1 has the structure shown in FIG. 2(b), and is set to have the refractive index n of 2.2 and the normalized grating period P/λ of 0.7. FIG. 12 is a graph showing a diffraction efficiency of the second polarization split element of Embodiment 1 of the present invention in the case where n is 2.2 and P/λ is 0.7, FIG. 12(a) shows a zeroth-order diffraction efficiency of a TE polarized light beam, and FIG. 12(b) shows a first-order diffraction efficiency of a TM polarized light beam.

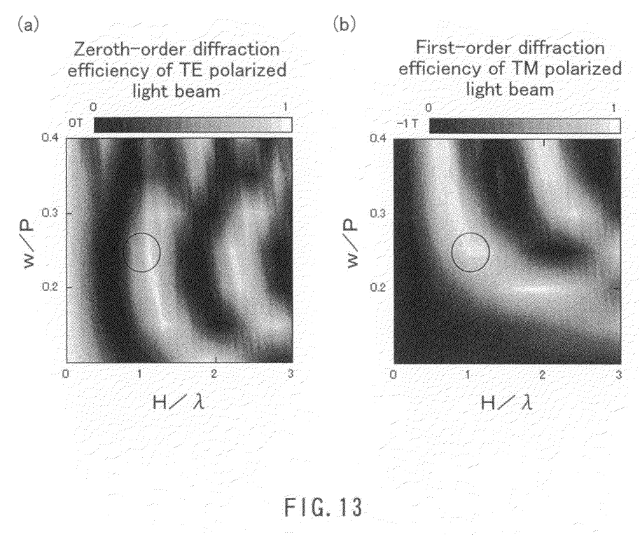

In addition, calculation results of the characteristic of another second polarization split element 1b of Embodiment 1 with the refractive index n of 2.2 and the normalized grating period P/λ of 1.0 also will be shown. FIG. 13 is a graph showing a diffraction efficiency of the second polarization split element of Embodiment 1 of the present invention in the case where n is 2.2 and P/λ is 1.0, FIG. 13(a) shows a zeroth-order diffraction efficiency of a TE polarized light beam, and FIG. 13(b) shows a first-order diffraction efficiency of a TM polarized light beam.

In FIGS. 12(a), 12(b), 13(a) and 13(b), a horizontal axis represents the normalized grating height H/λ obtained by normalizing the grating height H by the wavelength λ of the light to be used, a vertical axis represents a duty ratio w/P that is a ratio of the grating width w with respect to the grating period P, and the diffraction efficiency in the case of changing them continuously is mapped with contour lines. In the figure, the diffraction efficiency is shown by a grey scale where a color of black to white represents 0% to 100%, respectively. That is, a position in a color closer to white exhibits a higher diffraction efficiency.

In FIGS. 12(a) and 12(b), a range in which both of the zeroth-order diffraction efficiency of the TE polarized light beam and the first-order diffraction efficiency of the TM polarized light beam are high is marked with a circle. Also, in FIGS. 13(a) and 13(b), a range in which both of the zeroth-order diffraction efficiency of the TE polarized light beam and the first-order diffraction efficiency of the TM polarized light beam are high is marked with a circle.

An example of the structure and the characteristic of the second polarization split element 1b of Embodiment 1 in this range will be shown below, respectively.

Firstly, the case where the normalized grating period P/λ is 0.7 will be shown.

Refractive index n: 2.2

Normalized grating period P/λ: 0.7

Incident angle θ: 45°

Normalized grating height H/λ: 1.12

Duty ratio w/P: 0.37

Aspect ratio: 4.3

Zeroth-order diffraction efficiency of TE polarized light beam: 90.3%

First-order diffraction efficiency of TM polarized light beam: 91.5%

First-order diffraction efficiency of TE polarized light beam: 0.58%

Zeroth-order diffraction efficiency of TM polarized light beam: 0.64%

Extinction ratio on first-order side: 21 dB

Extinction ratio on zeroth-order side: 22 dB

Next, the case where the normalized grating period P/λ is 1.0 will be shown.

Refractive index n: 2.2

Normalized grating period P/λ: 1.0

Incident angle θ: 30°

Normalized grating height H/λ: 1.1

Duty ratio w/P: 0.25

Aspect ratio: 4.4

Zeroth-order diffraction efficiency of TE polarized light beam: 95.2%

First-order diffraction efficiency of TM polarized light beam: 94.3%

First-order diffraction efficiency of TE polarized light beam: 0.74%

Zeroth-order diffraction efficiency of TM polarized light beam: 0.04%

Extinction ratio on first-order side: 34 dB

Extinction ratio on zeroth-order side: 21 dB

As is realized from the above-described results, in the case where P/λ is 0.7, the second polarization split element 1b of Embodiment 1 with the refractive index n of 2.2 has the grating height H that is decreased by about 64% and the aspect ratio that is decreased by about 45%, compared with those of the conventional second polarization split element with the refractive index n of 1.47.

Moreover, in the case where P/λ is 1.0, the second polarization split element 1b of Embodiment 1 with the refractive index n of 2.2 has the grating height H that is decreased by about 62% and the aspect ratio that is decreased by about 48%, compared with those of the conventional second polarization split element with the refractive index n of 1.47.

As described above, the second polarization split element 1b of Embodiment 1 has a favorable characteristic. Moreover, as described above, the grating height H and the aspect ratio of the second polarization split element with the favorable characteristic depend on the refractive index n. Further, since the grating height H and the aspect ratio of the second polarization split element 1b with the favorable characteristic also depend largely on the grating period P, the grating period P is also required to have an optimal value.

Here, in the second polarization split element 1b with the structure shown in FIG. 2(b), while setting the normalized grating period P/λ to have four values of 0.6, 0.7, 0.8 and 1.0, and varying the refractive index n in a range from 1.5 to 2.6 respectively, the aspect ratio, the normalized grating height H/λ and the zeroth-order diffraction efficiency of the TE polarized light beam were measured. Incidentally, the incident angle θ was set to be a Bragg angle (θ=sin⁻¹(λ/2P)) that can provide a high diffraction efficiency. Moreover, the second polarization split element 1b was designed such that the zeroth-order diffraction efficiency of the TM polarized light beam with respect to the zeroth-order diffraction efficiency of the TE polarized light beam was about 1% or less (the extinction ratio was about 20 dB), and the first-order diffraction efficiency of the TE polarized light beam with respect to the first-order diffraction efficiency of the TM polarized light beam was about 1% or less. Since the incident angle became significantly large when P/λ was 0.6 (the Bragg angle is 56.4°), a reflection loss was generated, thereby resulting in the decrease of the diffraction efficiency of the TE polarized light beam. Thus, the grating period less than this value is not preferred.

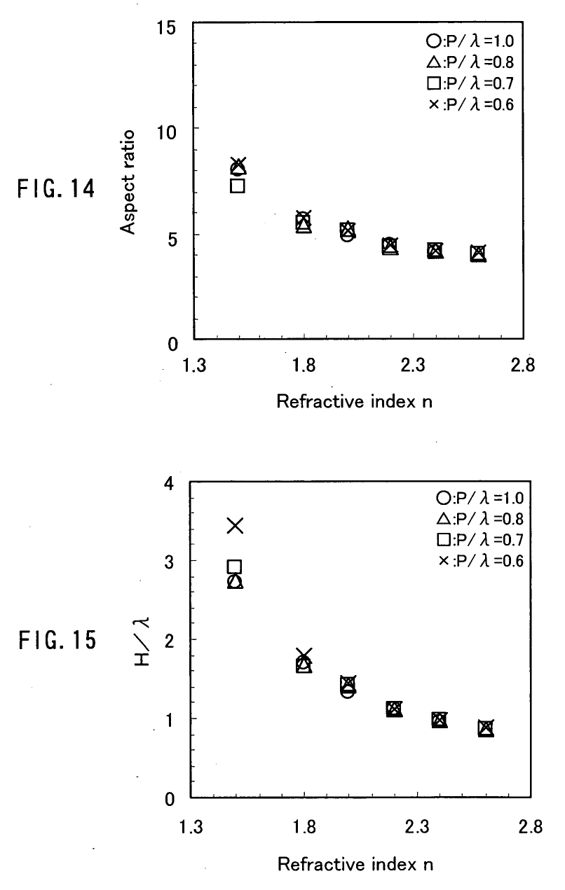

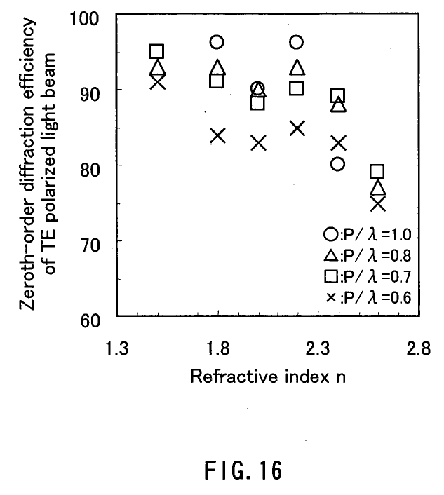

Measurement results thereof will be shown in FIGS. 14, 15 and 16. FIG. 14 is a graph showing a relationship between the aspect ratio and the refractive index n of the second polarization split element 1b. FIG. 15 is a graph showing a relationship between the normalized grating height H/λ and the refractive index n of the second polarization split element 1b. FIG. 16 is a graph showing a relationship between the diffraction efficiency (first-order diffraction efficiency of the TE polarized light beam) and the refractive index n of the second polarization split element 1b. Incidentally, in the respective figures, “x” denotes the case where P/λ is 0.6, “□” denotes the case where P/λ is 0.7, “Δ” denotes the case where P/λ is 0.8, and “o” denotes the case where P/λ is 1.0.

The following can be understood from FIG. 14. Firstly, the aspect ratio is decreased with the increase of the refractive index n, regardless of the value of the normalized grating period P/λ. Moreover, the dependence of the aspect ratio on the normalized grating period P/λ is small. Further, in the case where n is 1.8 or more, the aspect ratio is about 6 or less, regardless of the value of the normalized grating period P/λ.

The following can be understood from FIG. 15. Firstly, the normalized grating height H/λ is decreased with the increase of the refractive index n, regardless of the value of the normalized grating period P/λ. Moreover, the dependence of the normalized grating height H/λ on the normalized grating period P/λ is small. Further, in the case where n is 1.8 or more, the normalized grating height H/λ is about 1.8 or less, regardless of the value of the normalized grating period P/λ.

The following can be understood from FIG. 16. Firstly, in the case where the refractive index n is 2.2 or less, the high diffraction efficiency is maintained constantly regardless of the value of the normalized grating period P/λ, and when the refractive index n is more than 2.3, the diffraction efficiency is decreased with the increase of the refractive index n. Moreover, when P/λ is 0.6, the diffraction efficiency tends to be small.

From the facts described above, it is realized that the normalized grating height H/λ and the aspect ratio can be decreased significantly by increasing the refractive index n.

As described above, the range of the refractive index n and the normalized grating period P/λ of the second polarization split element 1b of Embodiment 1 is:

1.8≦n≦2.4, and 0.6≦P/λ≦1.0.

From FIGS. 14, 15 and 16, it is realized that the second polarization split element 1b of Embodiment 1 can suppress the aspect ratio to be 6 or less and the grating height to be about 1.8λ or less while maintaining the high diffraction efficiency. Thus, the second polarization split element 1b can be produced easily while maintaining its high performance.

Further, as described above, the refractive index n and the normalized grating period P/λ of the second polarization split element 1b of Embodiment 1 are particularly preferably in the range described below.

1.8≦n≦2.2, and 0.7≦P/λ≦1.0.

By setting the refractive index n and the normalized grating period P/λ to be in this range, the still higher diffraction efficiency can be achieved.

Moreover, as described above, since the aspect ratio of the first polarization split element 1a can be suppressed to be smaller than that of the second polarization split element 1b, the first polarization split element 1a can be produced more easily. However, the normalized grating period P/λ of the first polarization split element 1a is 0.8 or less, but the normalized grating period P/λ of the second polarization split element 1b may be 0.8 or more. Thus, in the case where the grating period P is difficult to be reduced, it is preferable to adopt the configuration of the second polarization split element 1b. Moreover, as the grating period P is larger, the incident angle θ is smaller, so that it is preferable to adopt the configuration of the second polarization split element 1b also in the case where the incident angle θ is required to be small. Thus, in the case where the normalized grating period P/λ is 0.8 or less, it is preferable to adapt the configuration of the first polarization split element 1a, and in the case where the normalized grating period P/λ is more than 0.8, it is preferable to adapt the configuration of the second polarization split element 1b.

Moreover, in the first and second polarization split elements 1a and 1b shown in FIGS. 2(a) and 2(b), respectively, the grating height H tends to be increased with the increase of the duty ratio w/P. For example, in the case of producing the second polarization split element whose wavelength λ of the incident light beam 4a is 0.67 μm, the grating height H of the conventional second polarization split element whose refractive index n is 1.47 is about 2 μm. However, in the case of the second polarization split element 1b of Embodiment 1 with the refractive index n of 2.2, the grating height H may be about 0.74 μm. For example, in the case of producing the second polarization split element 1b by forming a film with an arbitrary thickness on the substrate and forming grooves periodically on the film, the thickness of the film becomes the grating height H. Thus, like the conventional second polarization split element described above, in the case where the grating height H is 2 μm, the film with the thickness of 2 μm is required to be formed on the substrate. And, in the case of forming the film with such a thickness, a method for forming the film also is limited. For example, in the case of forming a film with a thickness of 1 μm or more by the sol-gel method, cracks are generally generated in the film by a volumetric shrinkage. Moreover, for example, in the case of forming a film by liquid phase deposition, a deposition rate is extremely small, so that it requires several tens of hours as a film forming time to form the film with the thickness of 2 μm. The film with the thickness of 2 μm can be realized in vacuum film formation that is represented by sputtering, chemical vapor deposition or the like, but even in such a case, it is natural that the increase of the film thickness brings an increase of a processing time and an increase of a membrane stress. Thus, the conventional polarization split element is also difficult to produce.

The production method of the first and second polarization split elements 1a and 1b of Embodiment 1 include, for example, a method of performing periodic groove processing with respect to a bulk material having a desired refractive index, and a method of forming a thin film of a material having a desired refractive index on the substrate and performing periodic groove processing with respect to the thin film. There are not many kinds of bulk materials with refractive indices of 1.6 or more and more preferably about 2.0, which are generally expensive. For example, a crystalline material such as sapphire is actually a high-refractive-index material but is birefringent, and is expensive. On the other hand, there are many kinds of thin films with refractive indices of 1.6 or more and more preferably about 2.0. Thus, in the case of producing the first and second polarization split elements 1a and 1b of Embodiment 1, it is preferable to adopt the method of forming the thin film on the substrate and performing the periodic groove processing with respect to the thin film.

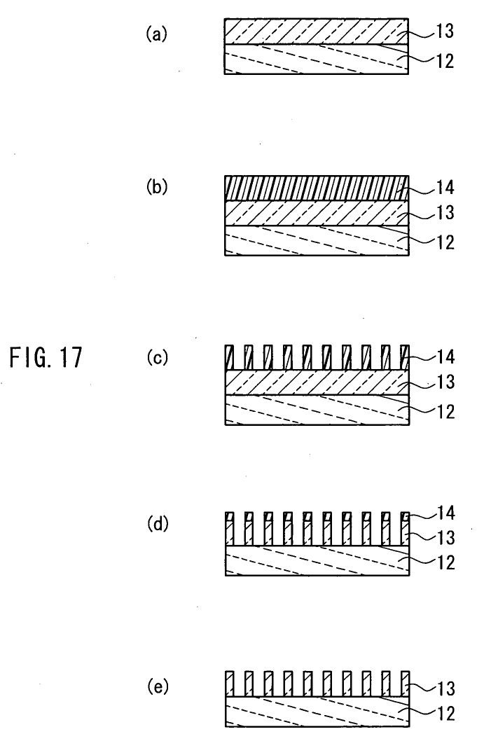

The production method of the first and second polarization split elements 1a and 1b of Embodiment 1 will be described below specifically. FIG. 17 shows cross-sectional views illustrating steps in the production method of the polarization split element of Embodiment 1 of the present invention.

Firstly, as shown in FIG. 17(a), a thin film 13 with a high refractive index is formed on the substrate 12. Since this thin film 13 becomes a material of the convex portion 3 of FIG. 1, a material with the refractive index n that is suitable for each of the first polarization split element 1a and the second polarization split element 1b is selected as the material of the thin film 13. Examples of the material of the thin film 13 with the high refractive index include Ta₂O₅, TiO₂, SiN, ZrO₂, MgO, Al₂O₃, TeO₂, SnO₂, ZnO, high-refractive-index multicomponent glass, a high-refractive-index polymer containing metal fine particles and the like. Moreover, the film formation method of the thin film may be physical vapor deposition and chemical vapor deposition such as vacuum deposition, ion plating and sputtering that are used generally. Further, examples of the method with a liquid phase include sol-gel coating, a liquid phase deposition and the like.

Next, as shown in FIG. 17(b), a polymer 14 is applied onto the thin film 13.

Next, as shown in FIG. 17(c), the polymer 14 is patterned in lines (line-and-space) that are arranged periodically so as to form a mask. For this patterning, a stepper, a two-beam interference light exposure method, laser lithography, electron beam lithography and the like, which are the methods using a photosensitive polymer (photoresist), can be used. Also, patterning by press molding represented by heat cycle nano imprinting and ultraviolet nano imprinting may be used.

Next, as shown in FIG. 17(d), the thin film 13 is subjected to dry etching so as to be processed to have a periodic groove structure. For the dry etching of the thin film 13 having the high refractive index, reactive ion etching, ion beam etching, ECR (electronic cyclotron resonance) etching and the like can be used.

Finally, as shown in FIG. 17(e), the polymer 14 remaining on the thin film 13 is removed.

Incidentally, in the production of the first and second polarization split elements 1a and 1b of Embodiment 1, the material, the film formation method, the patterning method and the groove processing method should be selected as appropriate, considering a waveband of the light to be used, processability and the like, and the materials and the methods are not limited to the materials and the methods described above. For example, mask processing should be selected by considering the groove processing method and durability of the mask.

Herein, the case of processing the thin film 13 using the polymer 14 as the mask material was exemplified for the explanation, but methods other than this may be used. For example, a method in which a metal thin film is formed on the thin film 13 with the high refractive index in advance, the pattern of the polymer 14 is transferred to the metal thin film by wet etching using an etchant or dry etching and the thin film 13 subsequently is processed may also be adopted. Also, a method in which the metal film is formed on the polymer 14 that is patterned and the polymer 14 subsequently is removed by using an organic solvent or the like so as to obtain a mask by the metal patterning (lift-off technology) may be adopted.

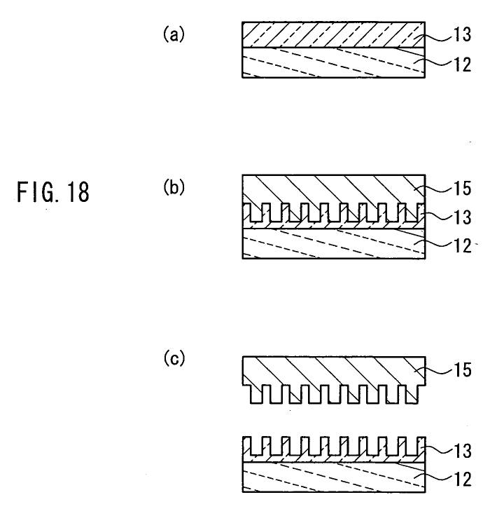

Next, another production method of the first and second polarization split elements 1a and 1b of Embodiment 1 will be described. FIG. 18 shows cross-sectional views illustrating steps in the production method of the polarization split element of Embodiment 1 of the present invention by using a mold. Incidentally, in FIG. 18, the members that are common with those of FIG. 17 are denoted by the same reference numerals, and the explanations thereof will be omitted.

Firstly, as shown in FIG. 18(a), the thin film 13 with the high refractive index is formed on the substrate 12.

Next, as shown in FIG. 18(b), the thin film 13 is subjected to press molding by a mold 15 having a periodic groove structure.

Finally, as show in FIG. 18(c), the mold 15 is removed.

This production method can reduce the number of steps, compared with the production method using the mask explained with reference to FIG. 17. Accordingly, the further cost reduction can be achieved.

The conventional polarization split element with the large grating height H and the high aspect ratio has a problem in that the polarization split element or the mold is likely to be broken at the time of being demolded. Also, since the structure of the mold has a periodic groove structure that is similar to the structure of the conventional polarization split element, a mechanical strength of the mold is small, and thus it is difficult to form the mold. However, since the first and second polarization split elements 1a and 1b of Embodiment 1 have the small grating height H and the low aspect ratio, the first and second polarization split elements 1a and 1b and the mold 15 are not broken at the time of being demolded. Moreover, since a mechanical strength of the mold 15 is also high, the mold 15 can be formed easily.

Incidentally, in the production method using the mold 15, it is desired to use a material with a low melting point as the material of the thin film 13 for increasing a yield at the time of the production. More specifically, for example, phosphorofluoridate glass and phosphate oxide glass and the like that are low-melting-point glass with high refractive indices may be used as the material of the thin film 13. If using such multicomponent glass, since the bulk material can be obtained by a fusion method at a relatively low cost, the first and second polarization split elements 1a and 1b may be produced by performing press processing with respect to the bulk material directly. Also, the thin film 13 may be formed by a so-called multitarget sputtering using a plurality of targets. Further, in the case of using the sol-gel method as the film formation method, for example, a method in which a sol-gel material is coated with a thin film, which is subjected to press molding by the mold 15 before being cured completely, and thereafter is cured by heat also may be adopted.

### Embodiment 2

Next, an optical pickup of Embodiment 2 of the present invention will be described with reference to the drawings. Incidentally, the optical pickup of Embodiment 2 is provided with the polarization split element of the present invention that is described in Embodiment 1 as the polarization beam splitter.

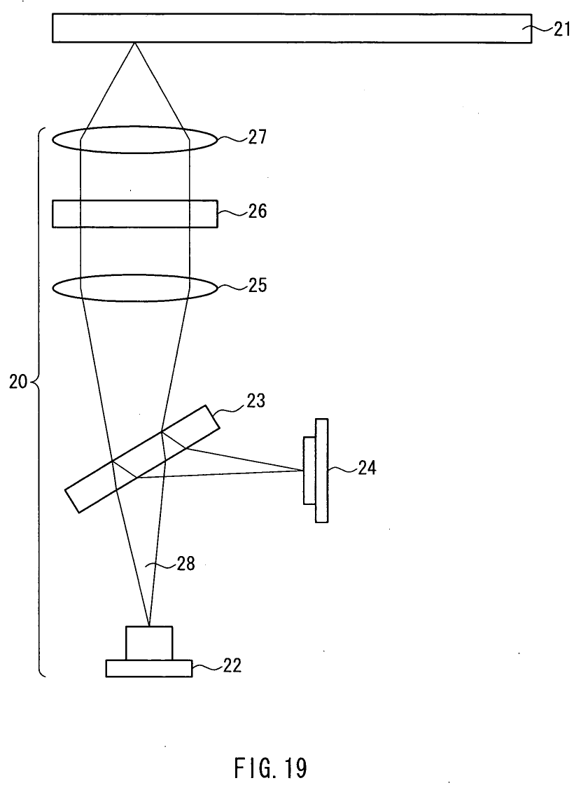

FIG. 19 is a schematic view showing a configuration of the optical pickup of Embodiment 2 of the present invention. As shown in FIG. 19, the optical pickup 20 of Embodiment 2 is provided with a laser diode (hereinafter, called a “LD”) 22, a polarization beam splitter (hereinafter, called a “PBS”) 23, a photodetector (hereinafter, called a “PD”) 24, a collimating lens 25, a wavelength plate 26 and an objective lens 27. Incidentally, as the PBS 23, the first polarization split element 1a or the second polarization split element 1b of Embodiment 1 is used.

The PBS 23 outputs the polarized light beams that are incident into the PBS 23 in optical paths that differ depending on the polarized light beams by diffraction (see FIG. 2). That is, the PBS 23 can split (branch) the polarized light beams by the diffraction. Incidentally, in the case where light beam including only one directional polarized light beam is incident, the PBS 23 does not split the incident light beam, but can change the optical path to have an arbitrary direction. Moreover, FIG. 2 shows the case where the incident light beam 4a is incident from the convex portion 3 side, but can split the polarized light beams similarly, even in the case where the light beam is incident from the substrate 2 side.

Next, operations of the optical pickup 20 will be described. Firstly, light beam 28 that is emitted by the LD 22 is diffracted by the PBS 23, and only arbitrary polarized light beam is incident into the collimating lens 25. The light beam 28 that is incident into the collimating lens 25 pass through the collimating lens 25 and the wavelength plate 26, and subsequently are converged on an optical disc 21 by the objective lens 27. The light beam 28 that is reflected on a surface of the optical disc 21 passes through the objective lens 27, the wavelength plate 26 and the collimating lens 25 in this order, and subsequently is diffracted by the PBS 23, and its optical path is changed so as to be incident into the PD 24.

According to the reflection on the optical disc 21 and the effect of the wavelength plate 26, a direction of polarization of the light beam that is incident from the LD 22 into the PBS 23 is different by 90° from a direction of polarization of the light beam that is reflected on the optical disc 21 and is incident into the PBS 23. Here, if the light beam incident from the LD 22 into the PBS 23 is only arbitrary polarized light beam, and the polarizing direction is TM for polarization split element 1a or TE for polarization split element 1b, it travels toward the collimating lens 25 without being split. Moreover, since the light beam after being reflected on the optical disc 21 have the polarization different from that of the light beam emitted by the LD 22, the optical path thereof is changed to have a direction different from an optical axis of the LD 22. If providing the PD 24 in this changed optical path, the light beam after being reflected on the optical disc 21 is incident into the PD 24. Incidentally, since the light beams after being reflected on the optical disc 21 also include only the same polarized light beams, all of the light beams travel toward the PD 24.

As described above, the optical pickup 20 of Embodiment 2 controls the polarized light beams, and thus has an effect of utilizing light that is higher than that of an optical pickup that does not control polarized light beams. Moreover, since the PBS 23 can be decreased in size, has a high performance, and can be produced at a low cost, the optical pickup 20 of Embodiment 2 also can be decreased in size, has a high performance, and can be produced at a low cost.

Moreover, in order to correct a position of an optical spot on the optical disc, a diffraction grating may be inserted between the LD 22 and the PBS 23, and as this diffraction grating, the first polarization split element 1a or the second polarization split element 1b of Embodiment 1 is desired to be used.

Incidentally, examples of the optical disc 21 include a CD (compact disc), a DVD (digital versatile disc) and the like, and also include a BD (blu-ray disc) that is developed as a next-generation high-density optical disc for practical use. Wavelengths of lasers of them for reading and writing are different from one another. More specifically, the wavelength of a laser of a CD for reading and writing is 0.78 μm, the wavelength of a laser of a DVD for reading and writing is 0.65 μm, and the wavelength of a laser of a BD for reading and writing is 0.405 μm (blue-violet laser).

Each of parameters of the PBS 23 will be shown below in Table 1 and diffraction efficiencies and extinction ratios of the PBS 23 will be shown in Table 2, in the case where the optical pickup 20 of Embodiment 2 is designed for a CD, a DVD and a BD. As the PBS 23, the first polarization split element 1a of Embodiment 1 (see FIGS. 1 and 2(a)) was used. Moreover, the incident angle θ was 45°, the refractive index of the substrate 2 was 1.47 and the refractive index n of the convex portion 3 was 2.2.

TABLE 1

| | Wavelength of | | Grating | Grating | | |
|---|---|---|---|---|---|---|
| | incident light | | period | width | | Grating height |
| Normalized | λ | | P = 0.707λ | w = 0.21P | | H = 0.62λ |
| For CD | 0.78 | μm | 0.551 μm | 0.116 | μm | 0.484 μm |
| For DVD | 0.66 | μm | 0.467 μm | 0.098 | μm | 0.409 μm |
| For BD | 0.405 | μm | 0.286 μm | 0.06 | μm | 0.251 μm |

TABLE 2

| | Diffraction | |
|---|---|---|
| | efficiency | Extinction ratio |
| Zeroth-order TE polarized light beam | 0.13% | 29 dB |
| Zeroth-order TM polarized light beam | 97.4% | |
| First-order TE polarized light beam | 90.7% | 20 dB |
| First-order TM polarized light beam | 0.95% | |

It can be realized from above-described Tables 1 and 2 as follows. That is, the zeroth-order diffraction efficiency of the TM polarized light beam is 97.4%, the first-order diffraction efficiency of the TE polarized light beam is 90.7%, and the extinction ratio is 20 dB or more. Moreover, the grating height H is 0.5 μm or less. As described above, the PBS 23 that has the significantly low grating height H, the high diffraction efficiency, and the high extinction ratio is realized.

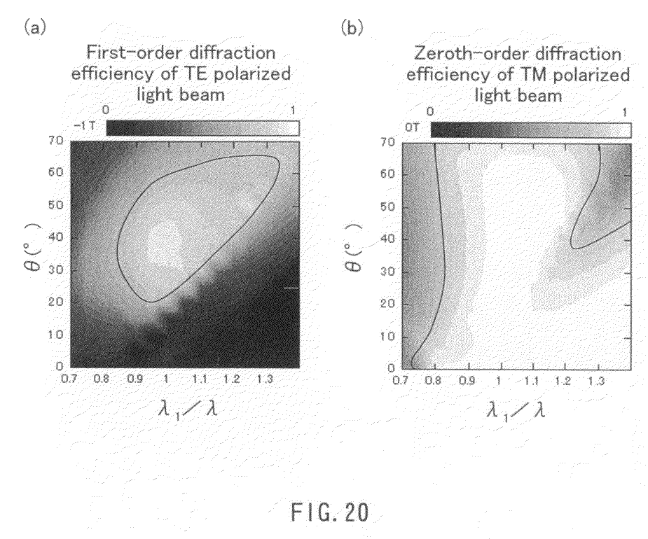

Moreover, dependence of the diffraction efficiency on the incident angle θ and the wavelength changing amount λ₁/λ of the light beam that is incident into the PBS 23 was calculated. Here, λ₁ denotes a wavelength of the light beam emitted by the LD 22. FIG. 20 is a graph showing dependence of the diffraction efficiency on the incident angle and the wavelength changing amount in the PBS used in the optical pickup of Embodiment 2 of the present invention, FIG. 20(a) shows a first-order diffraction efficiency of TE polarized light beam, and FIG. 20(b) shows a zeroth-order diffraction efficiency of a TM polarized light beam. In the figures, the diffraction efficiency is shown by a grey scale where a color of black to white represents 0% to 100%, respectively. That is, a position in a color closer to white exhibits a higher diffraction efficiency.

In FIGS. 20(a) and 20(b), a range with the high diffraction efficiency is inside an area enclosed by a solid line. And, the range in which both of the zeroth-order diffraction efficiency of the TM polarized light beam and the first-order diffraction efficiency of the TE polarized light beam are high is a range in which this PBS 23 can be used. As shown in FIGS. 20(a) and 20(b), the range in which the zeroth-order diffraction efficiency of the TM polarized light beam is high includes the range in which the first-order diffraction efficiency of the TE polarized light beam is high. Accordingly, the range in which the first-order diffraction efficiency of the TE polarized light beam is high is the range in which the PBS 23 can be used. The incident angle θ exhibiting the diffraction efficiencies of both of the TE polarized light beam and the TM polarized light beam to be 80% or more ranges from about 20° to about 60°, and the wavelength exhibiting the diffraction efficiencies of both of the TE polarized light beam and the TM polarized light beam to be 80% or more ranges from about 0.9λ to about 1.2λ (0.36 μm to 0.49 μm), and the allowable ranges of the incident angle θ and the wavelength are wide.

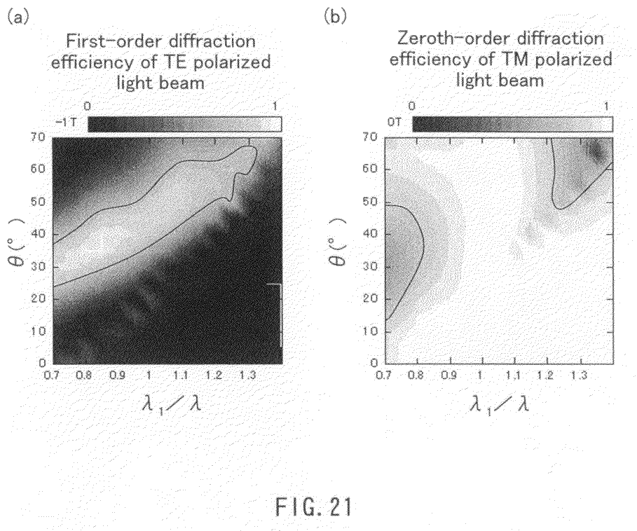

Incidentally, in the case of using the conventional polarization split element as the PBS 23, since the grating height H is large, the allowable range of the incident angle θ is narrow, and a range of a wavelength of light that can be used also is narrow. For comparison, also in the case of using the conventional polarization split element as the PBS 23, dependence of the diffraction efficiency on the incident angle θ and the wavelength changing amount λ₁/λ of the light beam incident into the PBS 23 was calculated. FIG. 21 is a graph showing the dependence of a diffraction efficiency on the incident angle and the wavelength changing amount in the conventional polarization split element used in the optical pickup, FIG. 21(a) shows a first-order diffraction efficiency of a TE polarized light beam, and FIG. 21(b) shows a zeroth-order diffraction efficiency of a TM polarized light beam. Incidentally, in FIGS. 21(a) and 21(b), a range with the high diffraction efficiency is inside an area enclosed by the solid line.

FIG. 21 is a graph that corresponds to FIG. 20. The conventional polarization split element has the grating period P of 0.7λ, the grating width w of 0.27 P, the grating height H of 1.3λ and the aspect ratio of about 7. A range of an effective incident angle θ of a light beam of an arbitrary wavelength, which exhibits a diffraction efficiency of 80% or more, is only about 10°.

Accordingly, the range of the incident angle θ of the optical pickup 20 of Embodiment 2 using the first polarization split element 1a of Embodiment 1 as the PBS 23 is about four times the range of the incident angle θ in the case of using the conventional polarization split element as the PBS 23. In the optical system of the optical pickup, light beams having certain range of incident angle is incident into the PBS 23 in most cases. That is, the wider allowable range of the incident angle θ is more preferable, and the wider range of the wavelength of the light to be used is more preferable. The optical pickup 20 of Embodiment 2 is provided with the PBS 23 using the first polarization split element 1a of Embodiment 1, and thus has a preferred characteristic. Herein, the case of using the first polarization split element 1a as the PBS 23 was exemplified for the explanation, but a similar effect can be obtained also in the case of using the second polarization split element 1b as the PBS 23.

Moreover, the PBS 23 of the optical pickup 20 of Embodiment 2 also can operate so as to perform polarization splitting with respect to two kinds of light beams having different wavelengths. Thereby, for example, the optical pickup 20 that conform to both of a CD and a DVD can be provided.

Parameters of the PBS that conform to both of a CD and a DVD will be shown in Table 3 below.

TABLE 3

| | Wavelength of | Grating | Grating | Grating |
|---|---|---|---|---|
| | incident light | period | width | height |
| Normalized | λ | P = 0.707λ | w = 0.21P | H = 0.62λ |
| For CD and DVD | 0.66 μm | 0.467 μm | 0.098 μm | 0.409 μm |

Diffraction efficiencies and extinction ratios of the PBS 23 in the case of using the optical pickup 20 for a CD will be shown in below Table 4, and diffraction efficiencies and extinction ratios of the PBS 23 in the case of using the optical pickup 20 for a DVD will be shown in below Table 5, where the optical pickup 20 is provided with the PBS 23 that is designed to have parameters shown in above Table 3. More specifically, the case of using the optical pickup 20 for a CD means a case where the wavelength of the incident light beam is 0.78 μm, and the case of using the optical pickup 20 for a DVD means a case where the wavelength of the incident light beam is 0.66 μm. Incidentally, as the PBS 23, the first polarization split element 1a of Embodiment 1 was used.

TABLE 4

| | Diffraction | |
|---|---|---|
| λ = 0.78 μm | efficiency | Extinction ratio |
| Zeroth-order TE polarized light beam | 0.67% | 22 dB |
| Zeroth-order TM polarized light beam | 95.9% | |
| First-order TE polarized light beam | 83.0% | 16 dB |
| First-order TM polarized light beam | 1.89% | |

TABLE 5

| | Diffraction | |
|---|---|---|
| λ = 0.66 μm | efficiency | Extinction ratio |
| Zeroth-order TE polarized light beam | 0.13% | 29 dB |
| Zeroth-order TM polarized light beam | 97.4% | |
| First-order TE polarized light beam | 90.7% | 20 dB |
| First-order TM polarized light beam | 0.95% | |

As is realized from the above-described Tables 4 and 5, the PBS 23 exhibits a favorable characteristic in either of the cases where the wavelength of the incident light beam is 0.78 μm and 0.66 μm. Accordingly, the PBS 23 for the two wavelengths that is applicable to a CD and a DVD can be realized by the first polarization split element 1a of Embodiment 1. By using such a PBS 23, the optical pickup 20 that conforms to the two kinds of optical discs and can save the number of members can be realized. Moreover, by combining a light source for the two wavelengths with this PBS 23, the number of the members can be saved further. Incidentally, the PBS 23 is not limited to a PBS for two wavelengths, and may be a PBS for a plurality of wavelengths other than the two.

### Embodiment 3

Next, an optical isolator of Embodiment 3 of the present invention will be described with reference to the drawings. Incidentally, the optical isolator of Embodiment 3 is provided with the polarization split element of the present invention that is described in Embodiment 1.

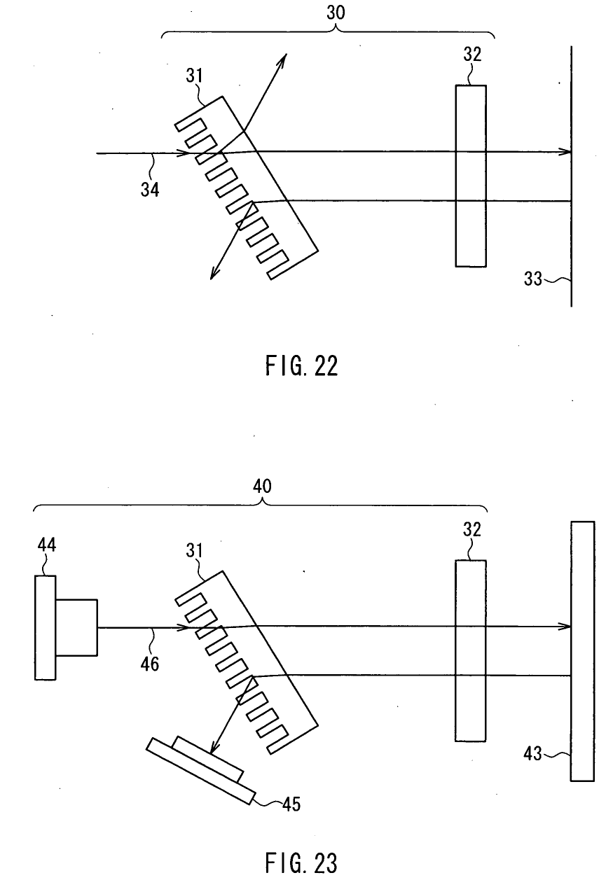

FIG. 22 is a schematic view showing a configuration of the optical isolator of Embodiment 3 of the present invention. As shown in FIG. 22, the optical isolator 30 of Embodiment 3 is provided with a polarization split element 31 and a ¼ wave plate 32. Incidentally, as the polarization split element 31, the first polarization split element 1a or the second polarization split element 1b of Embodiment 1 is used.

Next, operations of the optical isolator 30 will be described. Light beam 34 including TE polarized light beam and TM polarized light beam is incident into the polarization split element 31. The polarization split element 31 and the ¼ wave plate 32 are arranged such that only an arbitrary linear polarized light beam (for example, a TM polarized light beam) among polarized light beams that are split by the polarization split element 31 are incident into the ¼ wave plate 32. The TM polarized light beam is converted into circularly polarized light beam by the ¼ wave plate 32. This circularly polarized light beam is reflected on a reflective surface 33, and then is incident into the ¼ wave plate 32 again such that the rotating direction is reversed, whereby the polarization is rotated by 90° (for example, converted into TE polarized light beam). The light beam that is reflected on the reflective surface 33 and is incident into the polarization split element 31 is the TE polarized light beam, and thus travels along an optical path in a direction that is different from an optical axis of the light beam 34 when being output from the polarization split element 31. That is, the light beam reflected on the reflective surface 33 never return onto the optical axis of the light beam 34. As described above, the optical isolator 30 can block the reflected return light beam.

The optical isolator is used for preventing generation of noises caused by return light in optical fibers in optical communications, preventing surface reflection on display surfaces and the like. In the conventional optical isolator, a polymer film is used as the polarization split element. The optical isolator 30 of Embodiment 3 uses the first polarization split element 1a or the second polarization split element 1b as the polarization split element 31, and thus can be produced at a low cost and provides a high extinction ratio and a high diffraction efficiency. Moreover, since the polarization split element 31 can be made of an inorganic material, the optical isolator with high durability can be obtained.

Incidentally, as shown in FIG. 23, by adding a LD 44 and a PD 45 to the above-described optical isolator 30 (see FIG. 22), a polarizing hologram 40 is obtained. FIG. 23 is a schematic view showing a configuration of the polarizing hologram of Embodiment 3 of the present invention. The LD 44 can emit light beams 46 with arbitrary polarization toward the polarization split element 31. The polarization split element 31 and the PD 45 are arranged such that the light beam output from the polarization split element 31 is incident into the PD 45.

Next, operations of the polarizing hologram 40 will be described. The light beam 46 that is the arbitrary linear polarized light beam (for example, TM polarized light beam) emitted by the LD 44 is incident into the polarization split element 31. The polarization split element 31 and the ¼ wave plate 32 are arranged such that the TM polarized light beam output from the polarization split element 31 is incident into the ¼ wave plate 32. The TM polarized light beam is converted into circularly polarized light beam by the ¼ wave plate 32. This circularly polarized light beam is reflected on the optical disc 43, and then is incident into the ¼ wave plate 32 again such that the rotating direction is reversed, whereby the polarization is rotated by 90° (for example, converted into TE polarized light beam). The light beam that is reflected on the optical disc 43 and is incident into the polarization split element 31 is the TE polarized light beam, and thus travels along an optical path in a direction that is different from an optical axis of the light beam 46 when being output from the polarization split element 31, thereby being incident into the PD 45.

The polarizing hologram is mounted on the optical pickup, for example. The conventional polarizing hologram is produced by microprocessing a birefringent crystal, and there is a limitation in the reduction of a material cost. However, since the polarizing hologram 40 of Embodiment 3 uses the first polarization split element 1a or the second polarization split element 1b as the polarization split element 31, significant cost reduction can be achieved by selecting a low-cost material. The polarizing hologram 40 of Embodiment 3 can be produced at low cost, and provides the high extinction ratio and the high diffraction efficiency. Moreover, since the polarization split element 31 can be made of an inorganic material, the polarizing hologram with high durability can be obtained.

Incidentally, it also is possible to configure various types of optical devices, besides the isolator and the polarizing hologram described above, by using the first polarization split element 1a or the second polarization split element 1b of Embodiment 1. Since the first polarization split element 1a or the second polarization split element 1b can be produced at the low cost, and exhibits the high extinction ratio, the high diffraction efficiency and the high durability. Accordingly, if using the first polarization split element 1a or the second polarization split element 1b, it is possible to obtain the optical device that has high durability, can be produced at a low cost, and has a high performance.

Incidentally, the structures specifically illustrated in Embodiments 1 to 3 are just examples, and the present invention is not limited only to these specific examples.

### INDUSTRIAL APPLICABILITY

The polarization split element of the present invention has a high performance and can be produced easily at a low cost. Accordingly, the polarization split element of the present invention can be used for various optical circuits, optical apparatuses and the like, and high performances and cost reductions thereof can be achieved.

1. A polarization split element comprising a substrate and a plurality of ridge-shaped convex portions provided in parallel with one another at equal intervals on the substrate, light beam incident to the plurality of convex portions being polarization-split by diffraction,
wherein the following conditional expression is satisfied:
1.8≦n≦2.2, and 0.6≦P/λ≦0.8,
where n denotes a refractive index of the convex portion with respect to the incident light beam, P denotes a grating period that is a sum of the interval between the adjacent convex portions and a width of the convex portion, and λ denotes a wavelength of the incident light beam, and
wherein the incident light beam is split into: a TM polarization zeroth-order diffracted light beam whose magnetic field has a vibration direction that is the same as a length direction of the convex portion; and a TE polarization first-order diffracted light beam whose electric field has a vibration direction that is the same as a length direction of the convex portion.

2. (canceled)

3. A polarization split element comprising a substrate and a plurality of ridge-shaped convex portions provided in parallel with one another at equal intervals on the substrate, light beam incident to the plurality of convex portions being polarization-split by diffraction,
wherein the following conditional expression is satisfied:
1.8≦n≦2.4, and 0.6≦P/λ≦1.0,
where n denotes a refractive index of the convex portion with respect to the incident light beam, P denotes a grating period that is a sum of the interval between the adjacent convex portions and a width of the convex portion, and λ denotes a wavelength of the incident light beam, and
wherein the incident light beam is split into: a TE polarization zeroth-order diffracted light beam whose electric field has a vibration direction that is the same as a length direction of the convex portion; and a TM polarization first-order diffracted light beam whose magnetic field has a vibration direction that is the same as a length direction of the convex portion.

4. The polarization split element according to claim 3, wherein the following conditional expression is satisfied:
1.8≦n≦2.2, and 0.7≦P/λ≦1.0.

5. A production method of the polarization split element according to claim 1, comprising press-molding a film that is formed on the substrate by a mold having a periodic groove structure.

6. A production method of the polarization split element according to claim 1, comprising forming grooves periodically on a film that is formed on the substrate.

7. An optical pickup comprising the polarization split element according to claim 1.

8. The optical pickup according to claim 7, wherein the polarization split element performs polarization splitting with respect to a plurality of light beams that have different wavelengths.

9. An optical device comprising the polarization split element according to claim 1.

10. An optical isolator comprising the polarization split element according to claim 1.

11. A polarizing hologram comprising the polarization split element according to claim 1.

12. A production method of the polarization split element according claim 3, comprising press-molding a film that is formed on the substrate by a mold having a periodic groove structure.

13. A production method of the polarization split element according to claim 3, comprising forming grooves periodically on a film that is formed on the substrate.

14. An optical pickup comprising the polarization split element according to claim 3.

15. An optical device comprising the polarization split element according to claim 3.

16. An optical isolator comprising the polarization split element according to claim 3.

17. A polarizing hologram comprising the polarization split element according to claim 3.
